(19) United States
(12) Patent Application Publication
(10) Pub. No.: US 2021/0073467 A1
(43) Pub. Date: Mar. 11, 2021

(54) Method, System and Apparatus for Entering Text on a Computing Device

(71) Applicant: Kannuu Pty Ltd., Mount Kuring-Gai (AU)

(72) Inventor: Kevin W. Dinn, Mount Kuring-Gai (AU)

(21) Appl. No.: 16/880,715

(22) Filed: May 21, 2020

Related U.S. Application Data
(63) Continuation of application No. 16/537,226, filed on Aug. 9, 2019, now abandoned.
Application No. 16/537,226 is a continuation of application No. 16/218,048, filed on Dec. 12, 2018, now abandoned.
Application No. 16/218,048 is a continuation of application No. 12/449,985, filed on Feb. 22, 2010, now abandoned.
(60) Provisional application No. 60/905,295, filed on Mar. 7, 2007.

(51) Int. Cl. G06F 40/274; G06F 3/023

(52) U.S. Cl. CPC G06F 40/274; G06F 3/0237; G06F 3/0236

(57) ABSTRACT

A system, method and apparatus for entering information. A display is generated which includes one or more parts of the information. Selection of the one or more parts of the information may be made and results in the generation of a display of further one or more parts for selection. The further one or more parts may be selected in order to add to the selected one or more parts to build a larger part or whole of words, sentences, messages, text, symbols and/or graphics.

### CROSS-REFERENCE TO RELATED APPLICATIONS

This application is a continuation of U.S. application Ser. No. 16/537,226, filed Aug. 9, 2019, which is a continuation of U.S. patent application Ser. No. 16/218,048, filed Dec. 12, 2018, which is further a continuation of U.S. patent application Ser. No. 12/449,985, filed Feb. 22, 2010, which is the National Phase of International Application No. PCT/AU2008/000297, filed Mar. 5, 2008, which further claims the benefit of U.S. Provisional Application No. 60/905,295, filed Mar. 7, 2007. The foregoing related applications, in their entirety, are incorporated herein by reference.

This application is related to U.S. Provisional Application No. 60/878,083, filed on Jan. 3, 2007, International Application No. PCT/AU2002/001154, filed on Aug. 26, 2002, Australian provisional application AU2002950801 filed Aug. 14, 2002, International Application No. PCT/AU2006/001151, filed on Aug. 11, 2006, Australian provisional application AU2005904378 filed Aug. 12, 2005, U.S. application Ser. No. 10/495,585 filed on Aug. 20, 2002, PCT/AU02/01114 filed Aug. 20, 2002, and Australian provisional application PS-1072, filed Mar. 13, 2002. Each of these applications is incorporated herein by reference in its entirety.

### BACKGROUND OF THE INVENTION

### 1. Field of the Invention

The present invention relates to an improved method, system, and apparatus for entering text or information, and more particularly, but not exclusively, to a method, system, and apparatus for entering text or information on a computing device that has a limited interface.

### 2. Description of Related Art

Text entry on a computing device can be a slow and error prone process, especially on a device with a limited interface. In order to assist a user with entry of text, some computing devices provide “word completion” functionality. In word completion systems the computing device takes note of a word beginning that has been entered so far and presents the most likely completions for that word. The user uses some input means to select one of the proposed completions to rapidly complete the word. The number of possible completions presented at a time is limited by the space available on the display of the computing device presented to a user. For example, in the case of a mobile phone, there is generally not enough room for more than about three options to be presented. However, there are usually many more than three possible completions so the most likely three may be determined based on a knowledge of the likelihood of words in the language. Alternatively, the proposed completion may simply be presented alphabetically. If one of the presented completions is the completion that the user desires, they select it by some means, often by multiple movements of the joystick or directly indicating it with a press on a touch screen. However, if the desired completion is not presented then the user must enter one or more further letters until the desired completion is presented.

For example, in the case where a user wants to enter the word “technological”, after entering “tec”, FIG. 1 lists all the possible word completions that the system may consider as possibilities given an English dictionary of approximately 14,000 words. In the table, the list of possible word completions are listed in order of likelihood based on an analysis of documents written in English.

Assuming the screen only has room for three completions it would present the options: “hnology”, “hnical” and “hniques”. None of the three options presented correspond to the desired word “technological” so the user has to keep typing letters explicitly.

However as can be seen in FIG. 1, even after entering “tech” or “techn” the possible completions do not change. It is not until the user enters “techno” that the completions will change to “logies” and “logical”. At this point the user can use some input means to highlight and select the second option and the word will be completed.

The process of entering the word using this conventional technique is very complex (requiring use of the keypad and the joystick with constant reference to the screen). Additionally, the usability of the system is very low due to the constant need to go through the cycle of entering a letter (looking at the keypad), checking the letter has been entered correctly (looking at the screen), then checking the completions (looking at the screen), then going back to the keypad until the completion of the desired word is presented. Then using some other input means to select the desired completion. This sequence is very disruptive to the user's thought patterns and causes stress and errors.

Additionally, the process is cumbersome and requires the user to be able to enter any letter in their language's alphabet as well as possibly numbers and other symbols. This is particularly onerous on devices with limited interfaces such as mobile phones, personal digital assistants (PDAs), remote controls, games consoles, etc. Specifically, on hand held devices with a keypad such as mobile phones (see, FIG. 2), the entry of alphabetic characters as well as numbers and symbols is achieved by repeatedly pressing the 12 number keys (0 to 9 and “*” and “#”). This method is complicated and unnatural. It requires accurate presses of generally very small buttons and results in accidental pressing of adjacent buttons. This conventional system also requires the user to be able to read and discern very small labels on the buttons, requires constant shift of gaze between buttons and the screen to track the input, and only allows the entry of one character at a time.

Other handheld devices, such as a PDA, may accept input through a touch screen (see, FIG. 3). These devices allow entry of search terms through generally two methods—an on-screen keyboard and handwriting recognition.

The on-screen keyboard method involves presenting an image of a keyboard on the screen. The buttons on the on-screen keyboard are often too small to be selected using fingers so a stylus is required. Additionally, the process is slow, and selection of individual characters is prone to errors. There are additional disadvantages to the on-screen keyboard method. For example, in the on-screen keyboard method, access to numbers and additional symbols usually requires at least two presses as they require the keyboard to go into another mode to allow access to them. Additionally, small key images are hard to see for those with any impairment of vision and hard to select for those with limited dexterity, characters are only entered one at a time, and the process generally requires two hands.

Handwriting recognition systems are also disadvantageous because of the high error rate in recognizing characters, the need for a stylus for input, the time required to enter each letter, and the constant cycle of entry and checking the entry and correction of misinterpretation of entries. Additionally, as with the above methods, characters are only entered one at a time, and the process generally requires two hands.

Even using a full keyboard for text entry is disadvantageous because it is still necessary to enter one character at a time.

Devices that do not have additional keys or input mechanisms for text input, are often limited to one or more directional input mechanisms such as a joystick or selection wheel, and, in some instances, a number of other buttons dedicated to certain functions. Devices in this category include such things as games consoles, handheld games systems, music players, and video players. Other devices, such as mobile phones, combine text input and/or other directional means to make selections.

In order to input text using these systems the user often has to use the directional control in conjunction with an on-screen representation of a keyboard to navigate through and enter text a character at a time. This process becomes increasingly slow and complex in proportion to the complexity of the text.

Currently, the predominant text entry methods of modern phones use the keypad to allow entry of alphabetic characters, numbers and punctuation marks. These are based on the keys of the numeric keypad being assigned a plurality of alphabetic characters in addition to the numeral of the key which are indicated as permanent labels on the keys. For instance, generally the (2) key is also used to enter the letters “a”, “b” or “c”, the (3) key enters “d”, “e” or “f”, and so on. For the user to specify which of the several character options they want to enter there are currently two predominant methods are conventionally used. These can be referred to as multi-tap or predictive. In the case of multi-tap input, the user presses the appropriate key one or more times in rapid succession to select the intended character. The characters of the key are cycled through with each press. For instance in the case of the (2) key which is marked as “2abc”, pressing this once would enter “a”, pressing it twice in rapid succession would enter “b”, and three presses would enter “c”. A further press would select (2) as would a single long-press of the button for rapid access to the numeric character associated with the key.

In addition it is generally possible to enter the diacritical versions of the letters with subsequent presses, so the full sequence of characters available through multiple presses of the (2) key could be “abc2äæåàáâãç” and a subsequent press would cycle the user back to the start (“a”).

In order for multiple presses to be implemented a maximum amount of time must be defined, if two presses of the same key occur within this time interval then this is treated as a multi-press and the user is cycled through to the next character. If a key is pressed and there is no other activity within the maximum interval then the character is inputted to the system and subsequent presses will start at the beginning of the sequence for the key, even if it is the same key. Thus, to enter the text “ba” the sequence would be: (2), (2), <pause>, (2), <pause>. Without the first pause the user would enter just “c” instead. The maximum interval is generally between 0.5 and 1.5 seconds and sometimes the device allows the user to configure this themselves.

Additionally, a multi-tap system often provides a facility to accelerate the entry of two concurrent characters using the same key without having to wait for the maximum pause interval to expire. Often this is done through a press in or right of the joystick. Thus entering the string “ba” could be achieved through the sequence: (2), (2), <right press of the joystick>, (2).

A system that attempts to streamline the above process uses “disambiguation” to allow for the same text to be entered with less key presses necessary. A popular example of a disambiguation system is the product “T9”.

With predictive input, when the user wants to enter a particular letter they press the corresponding key once even if that key is associated with more than one letter, e.g. if the user wants to enter the letter “b” they could press the (2) key once even though the (2) key is associated with characters “a”, “b” and “c” as well as potentially the diacritical characters as described above. This introduces an ambiguity which is resolved through the system having a knowledge of the vocabulary of the language.

The system is programmed with a list of the words of the language as well as a corresponding likelihood for each one. It may also be programmed with rules of the vocabulary of a language such that even if the user is entering a word not pre-programmed the system can take educated guesses at the likely letters intended based on general principals of sequences of vowels, consonants and syllables of the language.

The system may also be programmed to take into account sequences of words as well such that the likelihood of a particular word could be dependent on the words that have been entered immediately before the current one.

In order to disambiguate the word the system has the user complete the key presses for the complete word and “disambiguates” these key presses to the most likely intended word. For instance, for the user to enter “bat” they would press the three key sequence: “2abc”, “2abc”, “8tuv”. The system would then present the most likely word that would be intended by this key sequence. This raises one of the main disadvantages of the system: there is potentially more than one word that could correspond to a sequence of ambiguous key presses.

For the above example, as well as “bat”, another possible word for that sequence is “cat” which the system may consider more likely, thus it could present “cat” to the application that the user is using (e.g. writing an SMS) rather than the intended “bat”. This then requires the system to provide an interface for the user to select an alternate word based on the ambiguous sequence of keys they pressed when the one presented is not the intended one.

Accordingly, in view of all the limitations of current systems, there is a need for an improved method of inputting text and information.

### SUMMARY OF THE INVENTION

The present invention provides text entry through the use of what is referred to throughout this application as, Partial Word Completion. Partial Word Completion text entry in one form is defined as a method of entering information or text on a device or computer interface that allows portions of the text or information to be entered by providing for selection of sections of strings to be entered through some input means until the entry of the complete string is complete. Partial Word Completion is not limited to a particular version of software but is rather a process as to how text or information is entered. A different definition of Partial Word Completion text entry is a method or system that allows information or text to be entered on a computing device with a limited interface where the users is presented with string sections that the system determines are likely to be what the user intends to enter based on a knowledge of the vocabulary, the user then goes through a sequence of repeatedly selecting the desired string sections until a complete string is built up. A further definition of partial word completion text entry is a method or system which provides text entry on a computing device with limited input means whereby substantially all the functions normally provided in a text entry system are provided through menus which are accessible through a limited means of a computing device. This would provide for text entry through the building up of known strings through repeated selections of proposed string sections until the complete strings are complete, but in addition the system would provide substantially all other functions to cater to any text entry activity including the ability to enter strings, that are not know to the system, by some explicit means which the system may then subsequently add to the dictionary. In addition other text entry functions may be provided, for example, capitalisation, entry of numbers and punctuation, editing functions, text entry tools like spell checking, and dictionary management functions.

In general, Partial Word Completion is a method of entering text or information on a computing device such as, for example, a handheld device. A strength of Partial Word Completion is that it allows such entry in an efficient way on a device with a limited interface.

In embodiments, Partial Word Completion may be applied to any computing device with a display and input device such as, for example, buttons, touch-sensitive screen or a joystick. The system may provide additional benefits to applications in the environment of devices with a limited input device including, for example, small, hand held devices like mobile phones, music players, PDAs, etc. or other devices which have a screen and limited input such as “lounge room” media devices, games consoles or information kiosks.

Embodiments, disclosed herein, may improve on standard word completion by not limiting the system to total word completions but allowing for sections of the word completion (i.e., partial words) to be presented for selection. In addition, disclosed embodiments make it much more difficult for the user to misspell or make spelling errors because the system provides words or partial word choices as compared with other conventional systems that rely upon the person entering the text to know ahead of time the appropriate spelling of the word being entered.

For example, once the user has entered “te”, out of a list of the 14,000 most common words in the English language there are 130 possible completions, (see, FIG. 4). It is very difficult to present all these options for the user to easily select from—especially on a device with limited interface such as, for example, a game system, music player or mobile phone.

However there are only approximately 10 word part continuations for the word start of “te”, These word parts are listed in the table in FIG. 5. This smaller number of options can be presented to the user and can be selected for example, by some limited means such as a joystick.

For the purposes of this document the term “joystick” applies to a broad range of input devices which allow the user to move or press a section of the mechanism to indicate a 2, or 3,-dimensional directional selection. The joystick may have a range of: 2 directions (e.g. up and down); 4 directions (e.g. left, right, up and down); 5 directions (e.g. left, right, up, down and in); 8 or 9 directions (with movements available as with 4 or 5 (respectively) directional joysticks plus movements in the 45% diagonal between each direction); or any other number of directional choices.

The joystick mechanism can be implemented many ways, including, but not limited to a structure that is on the device surface which pivots at the base and can be pushed in the desired direction by a thumb, digit, hand, mouth or some other means; a configuration sometimes known as a “d-pad” which is a pivoting surface which the user presses a section of to indicate a selection in that direction, the d-pad can be cross shaped which is common in many games controllers, or a solid rounded square, circle, ellipse or other shape which is common on many mobile phones, digital cameras, remote controls, etc.; A set of buttons on the surface of the device which are laid out in a configuration to allow the pressing of a button to indicate a directional selection; any other device or means for a user to indicate a selection in a direction.

In certain embodiments, a text entry system based on this principle may allow the user to select one of the proposed partial completions (based on the word entered thus far), append the selection to the word entered thus far, determine a new set of most likely part continuations and present them for selection. The user would then repeat this cycle until the word was complete. This method may facilitate more efficient text entry on devices which have traditionally either had cumbersome text entry means such as, for example, mobile phones, or no practical text entry means such as, for example, digital cameras.

Certain embodiments, may provide a method for entering text on a computing device. In an embodiment, the method may include: generating an initial display including one or more parts of a word for selection, enabling selection of the one or more parts and in response to selection of the one or more parts, generating a display of a further one or more parts for selection, and enabling selection of the further one or more parts in order to add to the selected one or more parts to build a larger part or whole of a word.

Certain embodiments, may provide a method of selecting items from a collection of items. The items may be identified by a sequence of components. In an embodiment, the method may include: generating an initial display including one or more parts of item identifiers for selection, enabling selection of the one or more parts and in response to selection of the one or more parts, generating a display of a further one or more parts for selection, and enabling selection of the further one or more parts in order to add to the selected one or more parts to build a larger part or whole of an item identifier.

In accordance with another embodiment, a device implementing the method of the present invention may include: means for generating an initial display including one or more parts of a word for selection, means for enabling selection of the one or more parts and in response to selection of the one or more parts, means for generating a display of a further one or more parts for selection, and enabling selection of the further one or more parts in order to add to the selected one or more parts to build a larger part or whole of a word.

In some embodiments, the word or string sections presented are based on some knowledge of the text indices in the list and the likelihood of the string or word sections to be the ones the user wants to enter.

In some embodiments, where the list of expected strings or word sections does not contain the desired entry the user is given an option to list “more” strings or word sections and is presented with a new list which indicates the next most likely set of string or word sections.

In some embodiments, when a string or word section is selected, a new list of string or word sections is presented to form a continuation of the text selection based on the string or word sections selected so far.

In some embodiments, the string or word sections are presented as labels on the screen to be selected by various methods depending on the type of device.

In some embodiments, where the device is a PC, the string or word sections would be selected by mouse presses or mapping to keyboard keys.

In some embodiments, where the device has a touch screen, such as, for example, on a PDA or Tablet PC, the string or word sections would be selected by pointing at the labels with either a finger or stylus.

In some embodiments, for example, where the device has a small screen and a joystick such as, for example, a mobile telephone or watch sized device, the string or word sections may be selectable from a menu which indicates which string or word section is selected for corresponding movements of the joystick.

In some embodiments, for example, where the device has function keys with the ability to associate an on-screen label with a button press the string or word sections may be presented for selection as labels with corresponding function keys.

In certain embodiments a method of entering information is provided, the method comprising: generating an initial display including one or more parts of a word for selection; enabling selection of the one or more parts and in response to selection of the one or more parts; generating a display of a further one or more parts of the word for selection; and enabling selection of the further one or more parts of the word in order to add to the selected one or more parts to build a larger part or whole of a word.

In some embodiments a method is provided that comprises iterating the selection steps until the word is completed.

In certain embodiments a method is provided wherein the method is performed on a computing device and the collection of words is stored on the computing device. In other embodiments a method is provided wherein the method is performed on a computing device and the collection of words is stored on a remote device.

In certain embodiments a method provided wherein generating said initial display includes selecting the one or more parts of the word to be displayed based on a dynamic prioritization scheme that adjusts priorities of the one or more parts of the word based on the number of times the word or the one or more parts of the word was previously selected.

In certain embodiments a method is provided wherein the information entered is text.

In certain embodiments a method is provided wherein the method further comprises generating a display of at least one function comprising: capitalisation, italic, bold, choice of font, colour, editing functions, deletion, cut, copy, paste, spell checking, grammar checking, word counting, and/or translation; enabling selection of the function for selection; and performing the at least one function selected.

In certain embodiments a method is provided wherein the method further comprises generating a display of at least one of a punctuation mark, a symbol, an accent, or a graphic, enabling selection of the at least one punctuation mark, symbol, accent, or graphic; and adding the at least one of the punctuation mark, the symbol, the accent, or the graphic to the information.

In certain embodiments a method is provided wherein if the list of expected parts of words does not contain the desired entry the user is given an option to list more parts of words and is presented with a new list which indicates the next most likely set of expected parts of words.

In certain embodiments the method is provided wherein the steps are repeated until an entire sentence is completed.

In certain embodiments a method is provided wherein the initial display may be either the one or more parts of the word, the function, the display of functions, the display of punctuation marks, symbols, accents, or graphics, the punctuation mark, the symbol, the accent, or the graphic.

### BRIEF DESCRIPTION OF THE DRAWINGS

Features and advantages of the present invention will become apparent from the following description of embodiments thereof, by way of example only, with reference to the accompanying drawings, in which:

FIG. 1 is a table showing all possible word completions for the string “tec” out of a dictionary of approximately 14,000 words;

FIG. 2 is a representation of a traditional mobile telephone layout;

FIG. 3 is a representation of a touch screen input device;

FIG. 4 is a table showing all possible word completions for the string “te” out of a dictionary of approximately 14,000 words;

FIG. 5 is a table showing all possible partial word completions for the string “te” out of a dictionary of approximately 14,000 words;

FIGS. 6A-6G illustrate partial word completion for the word “technological” in accordance with an embodiment of the present invention;

FIG. 7 is a table of the average number of clicks required to select items from lists of various sizes using a joystick based Partial Word Completion system in accordance with an embodiment of the present invention;

FIG. 8 shows a flowchart for interface component logic in accordance with an embodiment of the present invention;

FIG. 9 is a table showing a section of a word list for English out of a total list of 2,500 words including all words starting with “l” and all words forming the branch for words starting with “lea” indicated in bold in accordance with an embodiment of the present invention;

FIG. 10 shows an internal dynamic data tree diagram out of a sample of approximately 2,500 words showing the branch for words starting with “lea” in accordance with an embodiment of the present invention;

FIG. 11 shows a basic engine component lookup logic flowchart in accordance with an embodiment of the present invention;

FIG. 12 is a table illustrating entry of the word “leaders” in accordance with an embodiment of the present invention;

FIG. 13 shows an advanced engine component lookup logic flowchart in accordance with an embodiment of the present invention;

FIG. 14 is a table illustrating entry of the word “leaders” in accordance with an embodiment of the present invention;

FIG. 15 shows a pure priority engine component lookup logic flowchart in accordance with an embodiment of the present invention;

FIG. 16 is a table detailing the logic illustrated in FIG. 15 in accordance with an embodiment of the present invention;

FIG. 17 shows a dynamic tree with multi-character nodes (A) and single character nodes (B) in accordance with an embodiment of the present invention;

FIG. 18 shows an internal static tree diagram out of a sample of approximately 2,500 words showing the branch of menus leading to the selection of the word “leaders” in accordance with an embodiment of the present invention;

FIG. 19 details a process for the entry of the word “leadership” based on the tree in FIG. 18 in accordance with an embodiment of the present invention;

FIG. 20 details test data in accordance with using an embodiment of the present invention;

FIG. 21 details test data in accordance with using an embodiment of the present invention; and

FIG. 22 details test data in accordance with using an embodiment of the present invention.

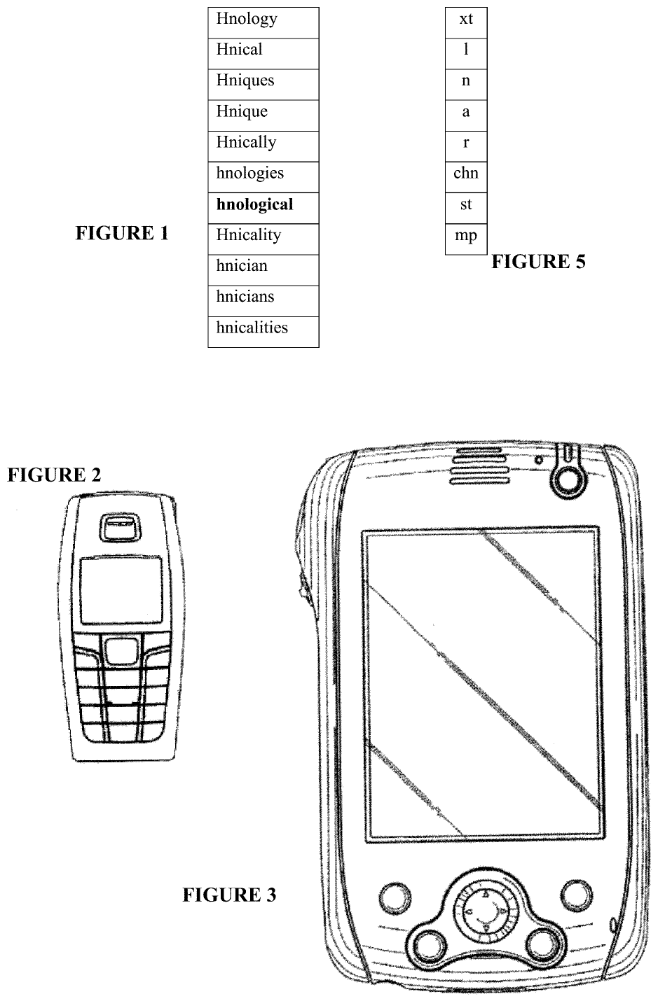

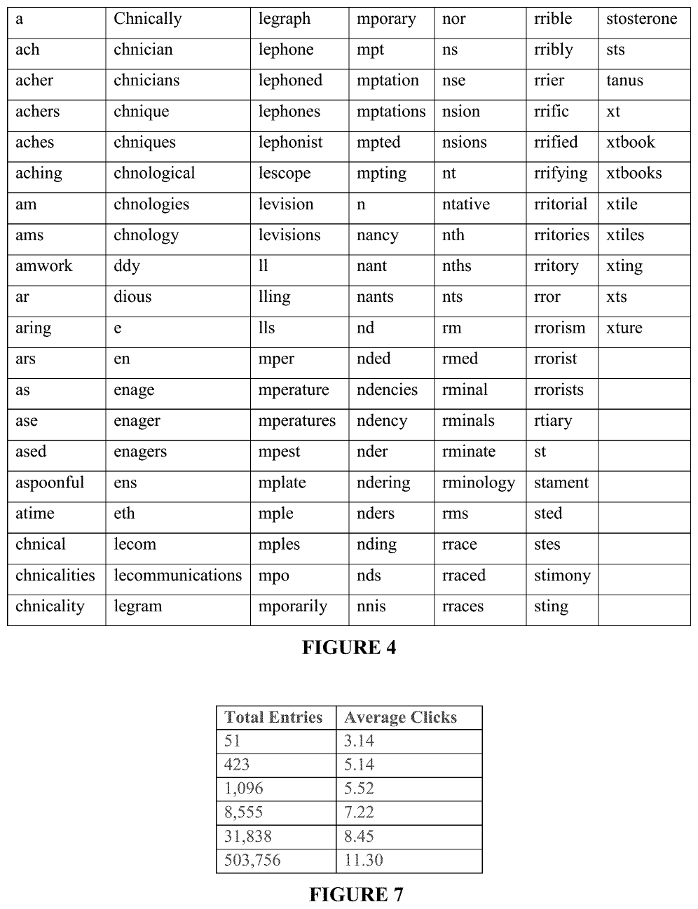

### DETAILED DESCRIPTION OF EMBODIMENTS OF THE INVENTION

A strength of Partial Word Completion is that it allows entry of text or information in an efficient way on a computing device. The text entry the embodiments disclosed herein also can facilitate access to other standard functions associated with text entry systems to be selectable through a limited input means. These functions may include, for example, capitalisation; formatting such as italic, bold, choice of font, colour; entry of numbers, punctuation marks, symbols, accents, graphics; editing functions such as selection, deletion, cut, copy, paste, etc.; activation of higher level tools such as spell checking, grammar checking, word counting, translation, etc.; navigation functions such as movement around a document, going to the top or bottom or scrolling up or down; application functions such as splitting windows; dictionary management functions allowing the user to add, remove or view the word(s) and associated priorities that make up the content of the predictive dictionary; and any other function that may be applicable to a text entry facility.

In certain embodiments, Partial Word Completion may be applied to most computing device with a display and input device such as, for example, buttons or a joystick. The system may provide additional benefits to applications in the environment of devices with a limited input device including, for example, small, hand held devices like mobile phones, music players, PDAs, etc. or other devices which have a screen and limited input such as “lounge room” media devices, games consoles or information kiosks.

In embodiments, the present invention may improve on standard word completion by not limiting the system to total word completions but allowing for sections of the word completion (i.e., partial words) to be presented for selection.

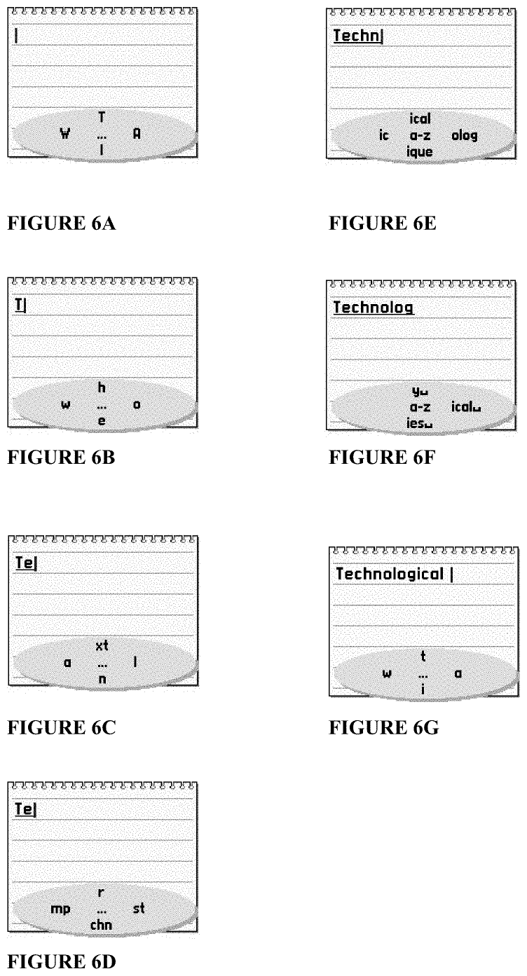

An exemplary embodiment of Partial Word Completion text entry will now be described with reference to FIG. 6A-6G.

In this example, text entry is being provided through a 5-way joystick of a device. The on-screen menu shows 4 Partial Word Completion options presented in an elliptical display with each of the four options being selectable by a movement of the joystick in the corresponding direction.

In addition the system in the embodiment provides a “more” option through some other control means which may be, for example, a press “in” of the joystick. In addition the system may provide a “back” option by some other control means to allow the user to undo previous actions.

FIGS. 6A-6G show an example of the system carrying out the same exercise described above (entry of the word “technological”) to provide a comparison of traditional text entry and Partial Word Completion.

In the embodiment, movement of the joystick in the direction indicated in the oval menu selects that option. If the option is not visible, then a click in of the joystick accesses the next most likely options.

FIG. 6A illustrates the start point with none of the characters of the word entered yet and with the menu presenting the four most likely letters to start a word in the English language (based on the vocabulary programmed into the system): T, A, I and W.

The user wishes to enter “technological” so they select “T” by pressing the joystick up.

In FIG. 6B, the display now indicates the letter “t” has been selected and entered as the first letter of the word, the menu now shows the most likely four word sections that could follow “t” in words in the English language based on the vocabulary programmed into the system. The user selects “e” by pressing the joystick down.

In FIG. 6C, The user has now entered “te” and the next most likely partial completions are presented (“xt”, “l”, “n”, “a”). Note that in this case one of the partial completions has two characters rather than just one as has been the case in the prior figures. A partial completion at any stage can have one or more characters. As the “c” needed to carry on the word is not visible, the user clicks the joystick in to activate the “more” option and go to the next set of four options.

In FIG. 6D, the user activated the “more” option there are no additional characters appended to the text but the menu of partial completion has been updated to reflect the next most likely four partial completions (“r”, “st”, “chn”, “mp”). As can be seen, a press down of the joystick will not only enter “c” but “chn” as the system has determined that a word starting with “tec” will want to carry on with “hn” so it is provided as a single selection.

As illustrated in FIG. 6E, in one movement of the joystick from the previous step, the user added 3 more characters to make the word to this point by “techn”. The most likely following completion options are presented. As can be seen the user can now make a press to the right which will select the next 4 letters “olog”.

In FIG. 6F, The word entered is now “technolog” and the system now presents only three options as these are the only continuations the system can envision for words starting with “technolog” based on its programmed vocabulary. As such each of the continuations (“y”, “ical”, “ies”) are also terminations and will complete the word. This fact is indicated in the example system with the space symbol (the bottom half of a character sized rectangle). At this point a press right will add “ical” and a space to finish this word and prepare to start the next word.

As seen in FIG. 6G, The word is complete with a space at the end and the system is ready to enter the next word so the menu has reverted back to the predicted partial completions for the start of a word as in FIG. 6A.

Using this method, the entire text (be it word or phrase etc.), can be entered as menu selections from the first letter onwards without the need for explicit character entry from a keyboard or keypad. This method allows text entry at a rate comparable or better than other systems for devices with limited user input. This method is also less stressful because the user does not have to use a small device keypad which means there are no mispresses of small keys and less fatigue and potential damage to the user's fingers and hand, the user's gaze remains on the screen at all times so there is not a constant flicking of focus between the controls and screen, the user is being guided through known text in the dictionary so it is impossible to misspell a selection, and the user is informed on the menu of what is available for selection.

Additionally, in embodiments, such as the one discussed above, it may be possible to prioritize entries, which makes text entry more efficient by making more common words faster to enter.

Additionally, in embodiments, the system does not rely on hardware labels. For instance, Asian mobile phones generally need to have different characters printed on their keys than those for countries using the Latin alphabet. With a Partial Word Completion based system the presentation of letters is done on-screen in software.

Partial Word Completion based text entry also encourages entry of full words rather than abbreviated text like “c u l8r”, this may be preferable for enterprise level messages and emails in general and particularly appealing to entry of languages with large words such as, for example, German. However, embodiments disclosed herein may be used effectively for abbreviated text like communication if the desired.

In certain embodiments, the system may not be limited to words, it could also work with phrases, numbers, abbreviations, Asian characters, icons, images, sounds, specialist concepts like chess moves, music notes, etc, or other types of text item or symbols.

As shown above, partial word completion makes it possible to enter several characters with one user input such as a key press or other user action. This may allow an application to be used efficiently with just a joystick whereas previously it relied on touch screen input. This also avoids the disadvantages of touch screen usage such as poor tactile feedback and marking of the screen with finger prints.

Because each option selection in partial word completion marks a choice of one branch out of a tree of options the result is that traversal through the tree, and hence selection of the desired item, happens at a rate which is more exponential than linear. To illustrate this point, FIG. 7 shows a table of the average number of clicks required to select items from dictionaries of various sizes using a joystick based Partial Word Completion system. As can be seen, as the number of items in the dictionary increases, the average number of clicks does not increase in linear proportion but more approximates an exponential curve.

The example illustrated above shows an application using Partial Word Completion where four options are presented at a time on a screen and these are selected using movements of a 5-way joystick. The press in the middle of the joystick is used to indicate “more” (for the user to indicate they do not see their desired option on the menu so bring up the next set). However, implementations of Partial Word Completion are not limited to this configuration. Any Partial Word Completion implementation may include several exemplary variations.

For example, the implementation may include a dynamic means of displaying one or more partial word options which can change based on the current entry context. Some of the options for this include: a small screen on a device, a large screen such as a television connected to a device, a “dialog” on a screen where the information is presented in a section of the screen whilst leaving other images or applications to use the rest of the screen, a system for audibly indicating the current options, presentation by touch, or any other means that conveys the information. The system may also include a dynamic means displaying the entry so far which could also be any of the display means listed above. The entry so far could be displayed separately or within some broader text such as a document being edited. Optionally the system could indicate which word was being edited (generally the last in the document) possibly by underlining it and Partial Word Completion options would be appended to this word within the document as they are selected. Alternatively a system may not present the entry so far at all, in which case the user may be expected to maintain their own memory of what has been entered so far. Various control means for the user to indicate which of the one or more options presented they want to select may also be provided. Some of the options for this could include: a joystick with the ability to indicate selections through two or more distinct movements, an array of buttons with some indication of how each button corresponds to a dynamic menu option, e.g. side keys where buttons are placed adjacent to the edge of the screen and option labels are displayed on the edge of the screen opposite the corresponding button, pedals, movement sensors in a device, gesture based interfaces detecting movements of the body of the user by means of cameras, motion sensors, etc, a touch screen where the user presses the portion of the screen corresponding to the desired option using fingers, a stylus or some other means, auditory input—using sound to indicate a selection, time based selection where a device could indicate selections cycled through over time and the user indicates a selection by activating some control means at the time that the desired option is indicated. In conjunction with, or instead of, the above there may be controls with static option strings which may be for options that are sufficiently common to warrant a permanent, dedicated control input. These controls may or may not have labels indicating their function.

The system may also include various control means for indicating the “more” function for the user to activate to indicate that their desired option has not been presented instead of selecting one of the one or more options presented. The mechanism for this control means may include any of the means listed above for the option selection control means but, due to the fact that the “more” option may be provided by some action which does not vary—it may also be provided by a simple static button, switch, etc. which does not need a dynamic means for indicating its function. An input means which allows the user to explicitly enter characters may also be provided. This could include a computer keyboard, mobile phone keypad, an on-screen keyboard on a touch screen device, etc. The user may make use of this option if the Partial Word Completion system is not presenting the partial continuation that the user desires for the current string input. This would be an alternative to use of a “more” function for situations where explicit input is for some reason preferable or the Partial Word Completion system does not provide a “more” function. When the user enters explicit characters, the Partial Word Completion menu may have to update itself to reflect the completion options for the newly entered word part. With the option of entering explicit characters, the user may enter a word part that does not correspond to any words known to the Partial Word Completion system which would then result in the menu showing no options to select and may need to be flagged as an error to the user if the system restricts input only to strings in the Partial Word Completion database.

In addition to the above minimal configuration, it may be desirable to also provide additional features. Such features may include, for example, a “back” function provided to allow the user to return to a previous state if they inadvertently made a selection they didn't want. This also can be provided through any static or dynamic input means similar to the “more” function.

A Partial Word Completion based text entry system may also need to provide an ability to enter more than just the words known to it in its programmed vocabulary. This will be the case when, for example, the user wants to enter some more obscure words in the language or proper nouns such as names. In this case the system needs to provide some means for entry of explicit characters in addition to the assistive logic of Partial Word Completion. In addition the system may also need to provide the ability to enter other characters such as punctuation, numbers, white space such as space and tab, etc.

Thus, some examples of interfaces for applications using Partial Word Completion could be a minimal configuration with a display of the entry so far and a single line menu display which indicates a single option with two buttons: one to indicate selection of the displayed item, the other to indicate “more”. A 5-way joystick where the options are presented in a menu as in the example above. Four options being presented as movements in the 4 directions of the joystick, and a press in of the joystick indicating “more”. Another example, may be a 5-way joystick similar to the configuration in the previous item but only 3 of the directions are used to present options (e.g. left, up and right) and the remaining direction indicating “back” to return to a previous state after an inadvertent action, and a press in of the joystick indicating “more”. Another example, may be a touch screen device like a personal digital assistant presenting a grid of 3 by 3 onscreen buttons. The top 6 being Partial Word Completion options for the user to select by pressing them. The bottom left being “back”, the bottom right being “more”, and the bottom middle button being available for some other application specific operation. A further example, may be a gesture based console game where the Partial Word Completion device is using a television screen to provide the menu of options in a circle of 4 Options with the “more” option being in the middle. The system would monitor the user's arm movements and use them as indications of selections of the options, a punch in the direction of the middle of the screen may activate “more”. Yet another example, may be, a personal computer where a four-way menu is displayed with options being selected by presses of the arrow keys. The “more” function could be provided by a press of the “Enter” key and the main keyboard could be used to enter explicit characters where the user wanted to bypass Partial Word Completion entry for some or all of the text.

The above is just a short list of the many possibilities of implementations of Partial Word Completion applications. Additional variation should be readily understood.

In order to implement a Partial Word Completion based system on a computing device using any interface means including those listed above, the system will preferably be made up of at least two major components: the interface component and the engine component.

The engine component performs the internal logic of determining the best Partial Word Completion strings to be presented and it may be supplied with information, including, but not limited to the “entry so far”, i.e. the part of the word or item being selected that has been entered so far, a list identifying zero or more menu items that have already been presented and rejected due to a “more” press or a number indicating how many levels in the menu to go down (e.g. how many times the “more” button has been pressed on this entry so far), and the number of menu options to return.

The interface component performs the management of the user input and output and queries the engine to supply the Partial Word Completion options strings to be presented in the menu for selection by the user activating some input means.

As described above, the user interface format could vary greatly and the number of options presented and the means by which they are presented and selected could vary as well. This is why the engine component takes as one of its parameters the number of options required. In the case of a system using a joystick based menu such as those illustrated in FIGS. 6A-6G the system would request four options (one for the menu locations for up, down, left and right). Other interface variations may require other numbers of options from one upwards.

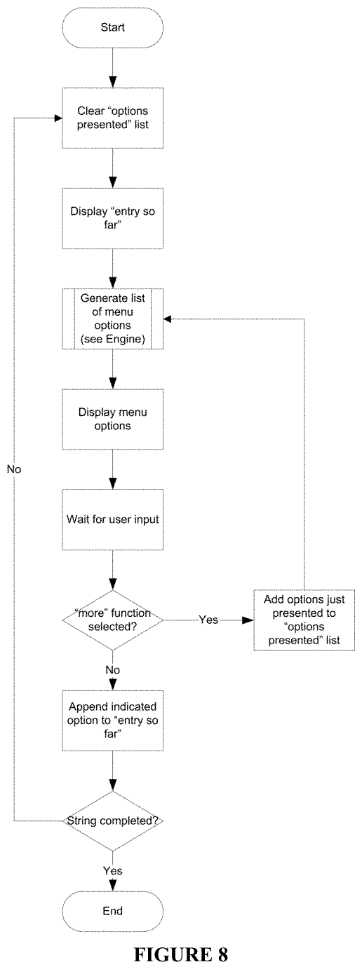

FIG. 8 illustrates a flow chart which details the logic that the interface component would apply to perform text entry based on Partial Word Completion. In an embodiment, the system may maintain: the “entry so far”, i.e. the part of the word or item being selected that has been entered so far, and the “options presented” identifying zero or more menu items that have already been presented and rejected due to a “more” press.

At the start point, the “entry so far” may be empty or it may have the beginning of a string which has been entered prior to beginning Partial Word Completion selection. The system starts by clearing the list of “options presented”. The system uses its output means to display the entry so far. The system calls the engine component providing it the “entry so far”, the “options presented” list and the number of options it requires. The engine component will then return a list of options to present which would number from zero up to the maximum number of options specified. The system then populates the options menu on the output means with the items returned. The system then waits for the user to make some input action. If the input action is the action that activates the “more” function then the system appends the list options it has just presented to the “options presented” list so that the engine component will not present these again, it then returns to the third step above. The option that has been specified by the input action is appended to the “entry so far”, extending the string that is being entered. If the string is complete then the system exits, otherwise it goes back to the first step above for further input. Depending on the particular application that the Partial Word Completion system is incorporated in, there may be additional logic steps needed.

For example, in a text entry system the “entry so far” is generally a word being entered in a sequence of words, thus the “entry so far” may be displayed in-line within a word processor display within the document being edited. In this case it may be advantageous to highlight the word that is currently being entered by underlining it or some other means.

In embodiments, the action performed at the end may just be to complete the word, append a space and revert back to the start for entry of the next word. This space may be treated as a “soft space” such that if the next string input does not need a space, this automatically added “soft space” could be removed by the system without any additional action by the user. An example of when this situation would apply is when a word is entered followed by a period. The system would remove the space between the word and the period when the period was entered.

The system may also provide intelligence to automatically capitalize items where appropriate. The system may watch for events that indicate capitalisation should be performed such as the entry of a sentence terminator (e.g. period, exclamation mark, question mark) or the entry is at the start of a document or a word that has been capitalized by the user in the past or the word “I” in which case the system could automatically capitalize the appropriate letters of the string being entered as they are entered. If this option is provided it may be beneficial to allow the user to override this function where required.

Also, the system could incorporate a knowledge of the preferred way a word in the dictionary is capitalized. For instance it may store that the fact that “Smith” (being a proper noun) should be entered with a capital at the start and automatically do this whenever “Smith” is entered.

Additionally, the system may provide a means to explicitly capitalize a word such as with a shift key, some button to indicate to the system to capitalize the next letter entered or when a selection is made through a key press, having a long key press indicate that the selection should be entered with the first or all letters capitalized.

In some text entry systems of the present invention, it may be beneficial to provide some additional means for the user to enter non-word items including but not limited to: punctuation marks, numbers, diacritics, space, tab, icons, images, sounds, specialist concepts like chess moves, music notes, etc, or any other symbols. This function would be provided by additional tests after the “Wait for user input” stage of FIG. 8. Additional tests would be performed to determine whether the user has specified the input of such characters, if so they would be appended, any additional processing as a result of the appending will be performed (e.g. automatic capitalisation as described above) and the system may continue processing by going back to the start in the flowchart above. Also it should be noted that punctuation marks, etc. can be included in the strings that the Partial Word Completion based system is indexed on if that is deemed beneficial.

As discussed above, the system may also provide a “back” function which may result in the last action being undone. This would be incorporated as an additional test for the appropriate input action after the “Wait for user input” stage. If this action is detected, the system may undo the last action then go back to the second step in FIG. 8.

The system may further allow for input actions to perform explicit character entry. This also would be tested for after the “Wait for user input” stage. If this action is performed, the character specified may be appended to the entry so far and then the system would go back to the first step in FIG. 8.

Tests were conducted to compare an embodiment of text entry using partial word completion as disclosed herein with other conventional systems for text entry. Users of various ages, genders and levels of expertise entered the test string “I will be home late tonight this is text technology” on a mobile phone (model: Nokia 6600) using three methods: multitap—a method used for entering text on many mobile phones that entails pressing keypad keys multiple times to differentiate between the multiple letters corresponding to each key; disambiguating predictive text using Tegic's T9; and an embodiment disclosed herein using partial word completion through a joystick on the phone.

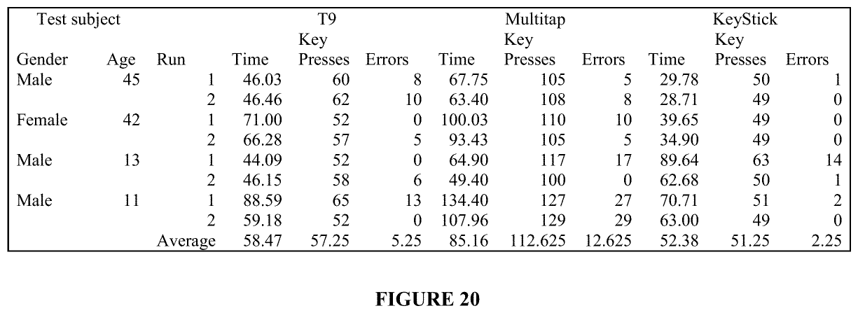

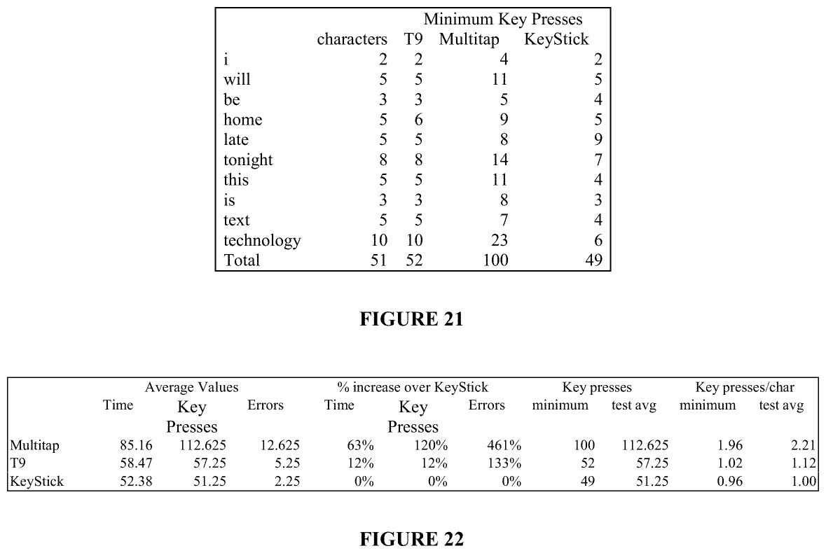

The test subjects had instruction in each method and an opportunity to familiarise themselves with each method. They were then asked to enter the test string exactly as written as quickly as possible, twice using each method. For each method of inputting the text into the phone, an average across all test subjects was calculated for the number of seconds to enter the test string, the number of key presses used to enter the test string, and the number of errors. An error was defined as the key presses made in excess of the minimum required to enter the text. The following table 1 (see also FIGS. 20, 21, and 22), shows the average number of seconds across all the test subjects to enter the test string:

TABLE 1

| Method | Average seconds |
|---|---|
| Multitap | 85.16 |
| T9 Disambiguation | 58.47 |
| Partial word completion | 52.38 |

Partial word completion applied to text entry using a joystick as compared with other existing text entry systems was approximately 12% faster as compared with T9 and approximately 62% faster than a multitap based text entry. Next key presses were measured. For the purposes of this application the term “key press” is used as a general term to refer to any discrete individual input action that the user does to carry out a function of the device including, but not limited to, such things as pressing a button, moving a joystick, touching a touch screen, making a sliding or revolving movement on such things as a touch sensitive surface or a wheel mechanism.

The following table 2 (see also FIGS. 20, 21, and 22) shows the average number of key presses across all the test subjects to enter the test string as well as the theoretical minimum key presses that would be required to enter the test string. The table also shows the corresponding values for key presses per character:

TABLE 2

| | | | Key presses | |
|---|---|---|---|---|
| | Key presses | | per character | |
| Method | Minimum | Test average | Minimum | Test average |
| Multitap | 100 | 112.625 | 1.96 | 2.21 |
| T9 Disambiguation | 52 | 57.25 | 1.02 | 1.12 |
| Partial word | 49 | 51.25 | 0.96 | 1.00 |
| completion | | | | |

On average partial word completion based text entry took approximately 12% less key presses then T9, and approximately 46% less key presses than multitap. Also, partial word completion based text entry was the only one with a minimum number of key presses per character of less than 1.0 and an actual test result of key presses per character approximating 1.0. Error rates were also measured. The following table 3 (see also FIGS. 20, 21, and 22) shows the average number of errors encountered across all the test subjects to enter the test string:

TABLE 3

| Method | Average errors |
|---|---|
| Multitap | 12.63 |
| Disambiguation | 5.25 |
| Partial word completion | 2.25 |

Partial word completion based text entry had approximately ½ the average errors of T9 disambiguation, and approximately ⅕ the errors of multitap. Compared to the T9 and multitap, partial word completion based text entry achieves, at least one or more of the following improvements in user testing: 12% and 63% less time (respectively) taken to enter the test string; 12% and 120% less key presses (respectively) taken to enter the test string; less than 1.0 minimum key presses per character; less than or equal to 1.0 key presses per character in test results; and/or 133% and 461% less errors (respectively) encountered by test subjects while entering the test string.

The above results were achieved despite the fact that partial word completion based text entry was carried out primarily through the operation of the joystick and the other two systems made full use of the multiple keys of the keypad. In general, text entry using partial word completion typically takes less time, requires fewer key presses and results in fewer errors than conventional text entry techniques used on devices with limited interface, such as a cell phone.

In certain embodiments, text entry using partial word completion as disclosed herein may require between about 10% and about 85%, between about 10% and about 65%, between about 15% and about 60%, and about 10%, about 15%, about 20%, about 25%, about 40%, about 50%, about 65%, less time than that of conventional systems. In certain embodiments, text entry using partial word completion as disclosed herein may require between about 10% and about 85%, between about 10% and about 65%, between about 15% and about 60%, about 10%, about 15%, about 20%, about 25%, about 40%, about 50%, about 65%, about 75% less time than that of conventional systems to enter when used on computing devices that have a joy stick type function and a limited interface. In certain embodiments, text entry using partial word completion may require between about 10% and about 70%, between about 10% and about 55%, between about 15% and about 50%, about 10%, about 15%, about 20%, about 30%, about 45%, about 50%, about 65% less key presses than that of conventional systems. In certain embodiments, text entry using partial word completion may require between about 10% and about 70%, between about 10% and about 55%, between about 15% and about 50%, about 10%, about 15%, about 20%, about 30%, about 45%, about 50%, about 65% less key presses than that of conventional systems to enter when used on a computing device that have a joy stick type function and a limited interface. In certain embodiments, text entry using partial word completion may result in between about 15% and about 95%, and between about 40% and about 85%, between about 25% and about 50%, between about 40% and about 55%, about 30%, about 55%, about 50%, about 65%, about 75%, about 90%, and fewer errors than that of conventional systems. In certain embodiments, text entry using partial word completion may result in between about 15% and about 95%, and between about 40% and about 85%, between about 25% and about 50%, between about 40% and about 55%, about 30%, about 55%, about 50%, about 65%, about 75%, about 90% and fewer errors than that of conventional systems to enter when used on a computing device that have a joy stick type function and a limited interface. In certain embodiments, the invention may benefit from any combination of these improvements, including, but not limited to, for example, text entry using partial word completion may require between about 10% and about 85%, between about 15% and about 50%, between about 10% and about 75%, about 10%, about 15%, about 30%, about 50%, about 75% less time than that of conventional systems; between about 10% and about 70%, between about 10% and about 50%, between about 15% and about 65%, about 10%, about 15%, about 20%, about 30%, about 45%, about 55% of the key presses required in conventional systems, and/or may result in between about 15% and about 95%, between about 20% and about 75%, between about 40% and about 75%, about 20%, about 35%, about 50%, about 65%, about 75%, about 90% fewer errors than that of conventional systems.

In some embodiments one or more of the improvements disclosed herein can be measured by, for example, entering the following phrase “I will be home late tonight this is text technology” and measuring the improvements. In some embodiments one or more of the improvements disclosed herein can be measured by, for example, entering the following phrase “Partial word completion is cool” and measuring the improvements. In some embodiments one or more of the improvements disclosed herein can be measured by, for example, entering the following phrase “Text entry on a computing device can be a slow and error prone process, especially on a device with a limited interface.” and measuring the improvements.

The above details describe some possible interface and the issues relating to implementing an interface to provide a Partial Word Completion based meaning system. The interface component manages all the inputs from the user and provides feedback of the entry so far and the Partial Word Completion menu options for the user to select from. In order for the interface component to know what strings to present as menu options it may rely on an engine component to provide these based on knowledge of a dictionary.

The interface component receives input from the user and uses some mechanism to report to the user the string entered/selected so far as well as the partial word completion options that the user has the option of selecting from.

In order for the engine component to respond to a request from the interface component to supply a set of options to present, the engine component may have a knowledge of: the “dictionary data” that that the system should use to base its menu option suggestions on—this may be a reference to a file, a pointer to internal memory or any other means of indicating the location or contents of the data—this data may be in any format that can be processed by the engine component; the “entry so far”, i.e. the part of the word, string or item being selected that has been entered so far; the “rejected options”—the menu options that have already been presented and rejected through selection of the “more” function (if any) by the user for the current “entry so far” or a number indicating the number of full menus of options that have been rejected through the “more” function (if any) for the current “entry so far”, and the “number of options”—the number of menu options to return.

The above knowledge could be supplied at the time of the interface component request, and/or some or all of it may be maintained in memory between requests, and/or calculated from some other information.

Below are set out some possible methods for the interface component to provide the above information to the engine component. This is not an exhaustive list as other methods may be possible in accordance with the present invention.

A Stateless set of parameters would be highly versatile. All the information needed to derive the set of menu options is supplied at the time of request and there is no assumption made that the engine component has maintained any information about the state of the entry/selection process. When the interface component makes a call to the engine component to provide it with a set of menu options, it may provide the following parameters: the “dictionary data”, the “entry so far”, the “rejected options” (a list identifying zero or more menu items that have already been presented and rejected due to a “more” press for the current “entry so far”), and the maximum “number of options” required.

A variation of this may be to replace the rejected options (the list of options already presented) with a number indicating how many full menu sets of options have been rejected for the current “entry so far” through the selection of the “more” option. With this information, assuming the “dictionary data” and the “number of options” hasn't changed between requests, the menu items that have been rejected through the “more” option can be calculated. For example, if there have been two menus rejected through the “more” option and the “number of options” is 4 then the system would determine the first 8 items that would be presented and bypass them (as they have previously been rejected by the user for the current “entry so far”) and return the subsequent 4 items in the lookup logic.

In an application level state maintained set of parameters a more pragmatic approach is taken whereby information that is not likely to vary between requests is maintained by the engine component. This information may include the “dictionary data” and the “number of options”. In practice these two items are unlikely to vary significantly within an application execution.

Thus, when the interface component makes a call to the engine component to provide it with a set of menu options. In embodiments, it may provide, it may provide the “entry so far”, the “rejected options”—a list identifying zero or more menu items that have already been presented and rejected due to a “more” press for the current “entry so far”, and a variation of this may be to replace the rejected options with a number indicating how many full menu sets of options have been rejected for the current “entry so far” through the selection of the “more” option. With this information, assuming the “dictionary data” hasn't changed, the menu items that have been rejected through the “more” option can be calculated. For example, if there have been two menus rejected through the more option and the “number of options” is 4 then the system would determine the first 8 items that would be presented and bypass them (as they have previously been rejected by the user for the current “entry so far”) and return the subsequent 4 items in the lookup logic.

In the mode where the transaction level state is maintained, the engine component maintains a memory of previous calls from the interface component for one or more selection/entry transactions and/or the current state of the selection process such that the interface component may only have to supply information about the last action the user performed and the engine component updates its state information and responds with the menu options accordingly.

In this mode the interface component may not need to maintain state information but, if the engine component is tracking more than one transaction at a time, the interface may need to maintain a knowledge of an identifier to identify to the engine component the transaction that corresponds to that instance of the interface component. In this mode the engine component is likely to maintain a knowledge of the “dictionary data” and “number of options” such that this information does not need to be supplied at each request.

When the interface makes a call to the engine component to provide it with a set of menu options, it may provide the following parameters: a transaction identifier if the engine component is able to maintain multiple transaction states, and the action last performed by the user. The action last performed by the user may include, for example: Start—to start or restart the selection, clear the “entry so far” (in embodiments, the system may provide the option to have an “entry so far” value supplied on this call such that the selection starts at a particular “entry so far”); More—reject the last set of options presented and go to the next set of options for the current “entry so far”; Back—undo the most recent action, and revert back to the previous state including the previous menu and “entry so far”; Selection—an identifier indicating that one of the menu options has been selected and which one—the engine component may react to this by appending the string for that selection to the “entry so far” and then presenting the initial menu of options for the new “entry so far”; Reload—indicating that there is no change of state required for this request—this call may be useful when the interface wants the engine component to report back its state information; and End—finish the current transaction.

As with the parameter set modes, the engine component is likely to respond to requests with a set of menu options for the interface component to present. But in this mode, as the engine component is maintaining the state of the transaction, it may be beneficial for the engine component to respond with additional information such as: the “entry so far” and the transaction identifier—this may only be returned on a “Start” action to be retained by the interface component and supplied as a parameter to subsequent calls, or returned on each call as a verification mechanism.

In order to implement the engine component for providing the present invention on a computing device. Several components should be considered. These components include, for example, source data—what form will the source data be in to make up the options that are presented and how will this data be imported into the system, internal data—the system may find it advantageous to process the source data into some other format to expedite the processing and presentation of the Partial Word Completion options, and lookup logic—what is the process of analysing the data to devise the best set of options to present at any particular state of string entry or selection.

The internal implementation of the system could take several approaches, two of them (Dynamic tree index and Static tree index) are expanded upon below.

In a dynamic tree index implementation the system may maintain internal data in a tree form reflecting the structure of the text's supplied in the source data. In conjunction with each text, there may be an associated priority value which may influence the relative priorities of the items in the tree when the system is performing the analysis of which items to present as Partial Word Completion options.

This structure provides the ability to dynamically change the priorities and hence the sequence that options are presented in without the need for a restructuring of the internal data. This facilitates applications which may have priorities changing dynamically such as increasing the priority of words that are used more frequently. When a set of Partial Word Completion options are needed, the internal logic traverses the tree and returns the best options to present. The tree structure is, in embodiments, built up from some raw data. The simplest form of this data would take the form of a list of strings with, optionally, an associated priority value for each string. If the data has no specified priority values the system can assign each string a value of 1, this would allow the system to function but would remove any advantages of prioritization.

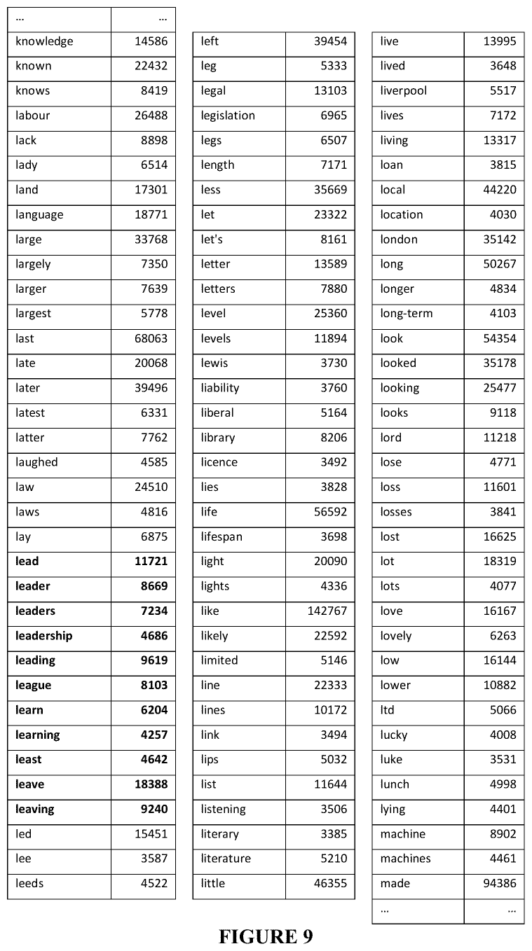

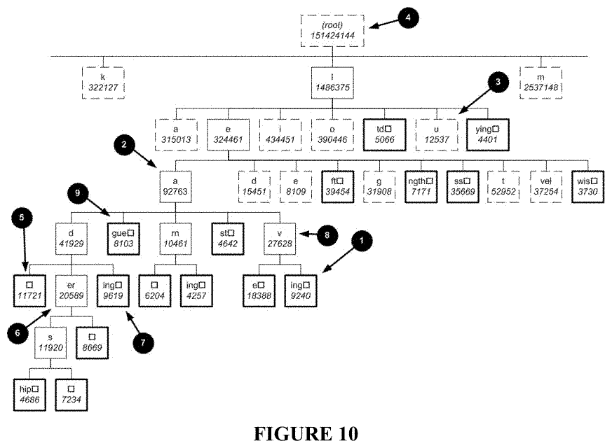

FIG. 9 is a table showing a section of a word list for English out of a total list of 2,500 words. The section includes all words starting with “l” as well as some words before and after these words. All words forming the branch for words starting with “lea” are indicated in bold. It is from this list that the tree in FIG. 10 has been built up.

In addition to a simple flat list, the data may come from any other source which could supply a set of strings with, optionally, a priority value for some or all of the strings. The data may come from a feed from a database for instance.

Alternatively the system may avoid the pre-processing stage of translating such a list and be provided the data directly in the tree structure described in the next section.

FIG. 10 illustrates a section of an exemplary dynamic tree structure for a dictionary. The section illustrated shows a region of the tree around the branch containing words starting with the letter “l”.

In the figure, each box represents a branch node or leaf node. Boxes with a bold border such as that indicated by (1) are leaf nodes which are at the periphery of the tree and correspond to the end of a word.

Nodes with a thin solid thin border such as that indicated by (2) are branch nodes which have all the branches below them expanded in FIG. 10. Nodes with a dashed border such as that indicated by (3) are branch nodes that have branches below them but these have not been fully expanded in the figure.

As illustrated in FIG. 10, each node has the following information associated with it: a string section of one or more characters or symbols which corresponds to that location; a priority value, for leaf nodes this may correspond to the priority for the string that that node is the termination of, for branch nodes it may be the sum of the priorities of all the nodes below it; a pointer to zero or more child nodes, and a pointer to the parent node.

Optionally each node may include a link or identifier or additional data describing an action to be performed when that node is selected or other data associated with the node/item selected, e.g. in a text entry application information about the word corresponding to the node such as formatting or whether it should be capitalised could be stored. Also other data associations such as if the entry is a business name the associated data may be contact details for that business which may be accessible by a separate user input.

If a program traverses from the root node (4) to any leaf node and concatenates the strings of each node in sequence they would build up the string associated with the leaf node reached. For example, if a system traverses to the leaf node (1), it would build up the string sections: “l”, “e”, “a”, “v”, “ing” making the word “leaving” which, based on the priority field in leaf node 4, has a priority of 9240.

In FIG. 10 it can be seen that the branch composed of all words starting with “lea” has been fully expanded. The top of the branch is indicated by (2).

It should be noted that to assist processing, each string may have an “end of word” symbol added to it. This allows a word termination to exist as a separate branch to other branches which are further continuations based on the same string. An example of this is the word “lead”. In FIG. 10 the branch to the complete word “lead” ends at node 5, however, there is also a branch node leading on to words starting with “leader” (6) as well as another termination node competing the word “leading” (7).

As described above, whatever the mechanism used for the interface component to supply parameters to the engine component, the engine component is likely to maintain or be provided with a knowledge of: the “dictionary data” that that the system should use to base its menu option suggestions on—this may be a reference to a file, a pointer to internal memory or any other means of indicating the location or contents of the data—this data may be in any format that can be processed by the engine component; the “entry so far”, i.e. the part of the word, string or item being selected that has been entered so far; the “rejected options”—the menu options that have already been presented and rejected through selection of the “more” function (if any) for the current “entry so far” or a number indicating the number of full menus of options that have been rejected through the “more” function (if any) for the current “entry so far”, and the “number of options”—the number of menu options to return.

Given this information, the engine component must traverse the tree to identify the nodes at which the most optimum menu options reside and return the information necessary for the interface component to present them to the user.

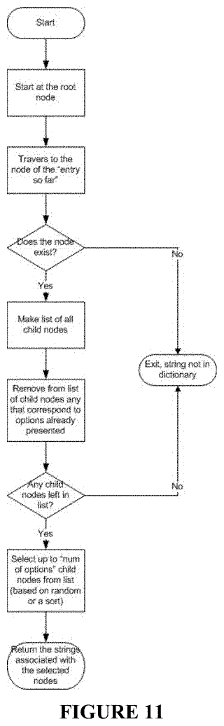

In one embodiment of the system the engine component could choose the candidates for presentation by the simple logic of returning the child nodes of the “entry so far”. FIG. 11 represents a flowchart of the logic that may be applied to do this.

The system would start with a pointer at the root node of the dictionary. It would the traverse the tree to the node corresponding to the supplied “entry so far”. If no corresponding node is found then the engine component would respond to the interface component to indicate that the supplied “entry so far” is not a know string in the dictionary. The interface component would then respond to the user according to the task being performed. In the case of text entry, it may provide an explicit character entry facility to spell out a word and then have that word added to the dictionary for subsequent entry. If the node is found then the system would compile a list of all the child nodes of that node. The system would then remove from that list all nodes of menu options that have already been presented. If, after the above step, there are no nodes left in the candidate list then the system would respond to the interface component that the entry was not found as described above. If the number of candidates is less than the supplied parameter “number of options” then the system would return all the candidates in the list, otherwise the system would select “number of options” items from the candidates and return them. The selection of the subset of nodes to return from the list and the order that those nodes are presented could be based on the objects with highest priority first, or random selection, or the first candidates based on some sort such as alphabetical order or some other means.

For example, if the user has entered the string “lea” and intends to enter the word “leaving”. The example interface is based on a five way joystick input with a menu indicating Partial Word Completion options in four directions of movement of the joystick similar to the menu in FIG. 6A.

The first call from the interface component would specify parameters including, for example: Entry so far: “lea”; menu items already presented: none; and number of options: 4.

Referring to FIG. 10, the system would start at the root node (4) and, based on the entry so far “lea”, traverse to the branch node 2. From that node it would identify all the child nodes (all the nodes below (2) in FIG. 10: “d”, “gue_”, “rn”, “st_” and “v” (note the character “_” is being used here to represent an end of word character)). From these 5 candidates, if it was selecting based on alphabetical order it would return the 4 menu options: “d”, “gue_”, “rn” and “st_”.

The interface component would then present these four options in the menu for the user to select from. As none of these options leads on to the user's desired word “leaving” they may select a “more” function, in which case the interface component may call the engine component again with the parameters: entry so far: “lea”; menu items already presented: “d”, “gue_”, “rn” and “st_”; and number of options: 4.

Once again the system would traverse to node 2 in FIG. 10 and it would then identify the same five child nodes as candidates (“d”, “gue_”, “rn”, “st_” and “v”) and then it would remove from this list of candidates the menu items presented already (“d”, “gue_”, “rn” and “st_”) leaving one candidate item (“v”). As the number of candidates (1) is less than the “number of options” (4)—all the candidates would be returned to the interface component for presentation.

The interface component would then present the one option returned (“v”). As this is a continuation of the word the user wants to enter, they would activate the input means to select that option. The interface component would then make another call to the engine component with the parameters: entry so far: “leav”; menu items already presented: none; and number of options: 4.

The engine component would then traverse to node 8 in FIG. 10 which corresponds to the string “leav”. It would then build the candidate list of the two child nodes (“e_” and “ing_”) and as they number less than “number of options”, both would be returned as options to the user interface component which would then present them for selection to the user. The user then selects the options “ing_” and their word or selection is complete.

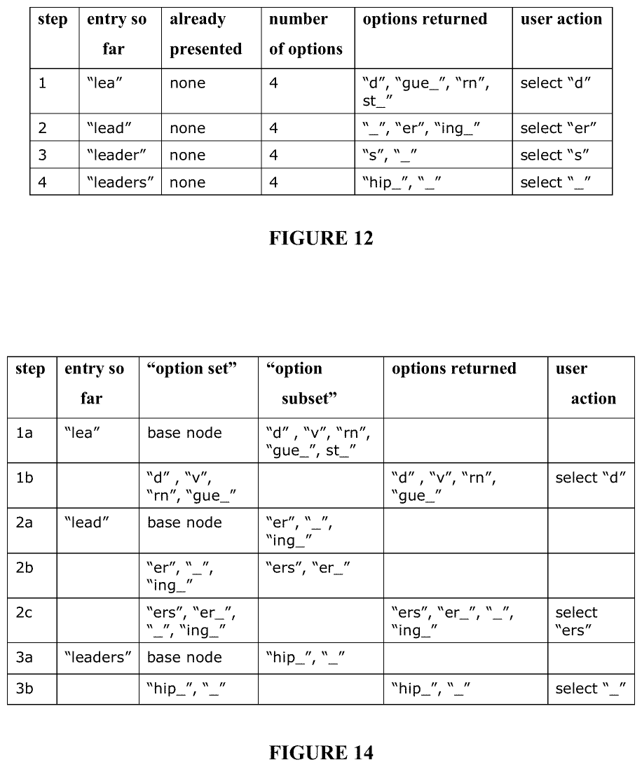

The above sequence is a viable implementation of Partial Word Completion menuing and provides a means of selection of menu options but it does not necessarily make the most optimum use of priority rankings. For instance Table I (FIG. 12) summarizes another example (selection of the word “leaders”):

The example in Table I (FIG. 12) above took four steps but it can be seen that in steps 2, 3, and 4, less options than the “number of options” value (4) were returned which is inefficient. In the next section, a method to rectify this inefficiency is described.

It is worth noting that using this “basic lookup” logic, once the tree structure has been built, the system managing the data may remove the priority figures from the nodes as this may not be necessary for determining the options to return. Even with the system wanting to present the options in priority order, as long as the tree structure reflects the correct ordering of the options such that they can be returned based on that ordering, it may not be necessary to maintain storage of the actual priority value. Removing this data from the tree structure may result in less storage being necessary for the data.

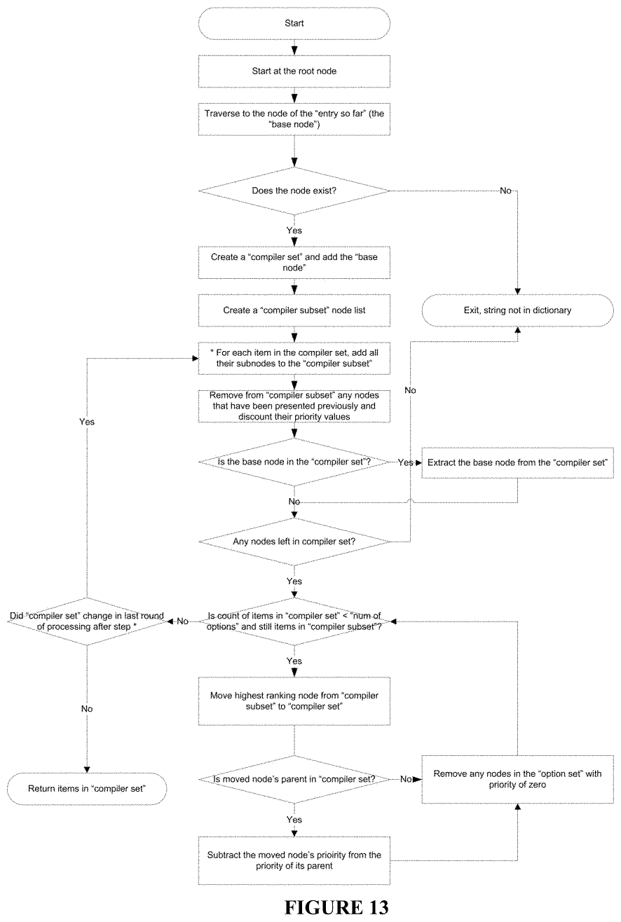

More optimal logic may perform additional processing when the child nodes were selected. This would fill out remaining slots in the menu by travelling further down the tree and picking the higher priority nodes further down the branch until all the “number of options” slots were full. One method for doing this is illustrated in the flowchart at FIG. 13 and described below.

The system would start with a pointer at the root node of the dictionary. It would the traverse the tree to the node corresponding to the supplied “entry so far” (the “base node”). It would create a list for holding nodes (the “compiler set”) and put the “base node” in it. It would create an additional list for holding nodes (the “compiler subset”), for every node in the “compiler set” get all their child nodes and put them in this list. It would remove from the “compiler subset” any nodes that have already been presented (and rejected as a result of the user selecting the “more” function), and delete their priority value from their parent's so they no longer contribute to this round of processing. If the “base node” is still in the “compiler set”, it would extract it—it is only needed there to kick-start this process. While the number of items in the “compiler set” is less than “number of options”, the system would take the node with the highest priority out of the “compiler subset” and add it to the “compiler set”, in the process subtract the priority value of the node just moved from any of its parent nodes in the “compiler set”. This is so that its priority does not get double counted. If the above process resulted in any node in the “compiler set” having its priority reduced to zero then it would take it out of the “compiler set”, this node has been completely subsumed by its child nodes, the system would delete the “compiler subset” as the remaining nodes will no longer be candidates, the system would repeat steps 4 to 8 until the “compiler set” contains “number of options” items and a cycle through the loop does not add or remove any nodes to the list, or compiler set” contains less than “number of options” but all child nodes have been added to it.

Based on the above logic, Table 2 (FIG. 14) summarizes the sequence used to select the word “leaders” from the data (note: the “number of options” column has been removed as it is always 4, and the “already presented” column has been removed as it is always none). As can be seen from Table 2 (FIG. 14) above, the user now has to make only 3 selections rather than 4 as in the method described in the previous section.

From the base node, all the child nodes (“er”, “_”, “ing_”) are added to the “option subset”, as these number less than “number of options” they are all transferred to the “option set” (step 2a). Then all the children of the nodes in the “option set” are loaded into the “option subset” (“ers”, “er_”) (step 2b). These are then transferred into the “option set” and, as they are added their priorities are subtracted from their parent (“er”) and ultimately this results in “er” having a zero priority so it is removed from the “option set” as “ers” and “er_” have completely subsumed the parent “er”. As this then results in “number of options” nodes, these are returned to the interface component. (step 2c). This method selects menu options ensuring all candidate branches that are children of the base node are presented and where there is room for more options, these are chosen from nodes further down the branches based on priority.

A further method of selecting the optimal nodes in the tree for determining the Partial Word Completion options to present would be to make priority the main driver for selection. In this case the system traverses the tree below the node for the “entry so far” (the “base node”) and selects up to the “number of options” nodes with the highest priority with the following proviso: the priority value is the node's priority value minus the priorities of any nodes below them on the tree which are being returned as candidates.

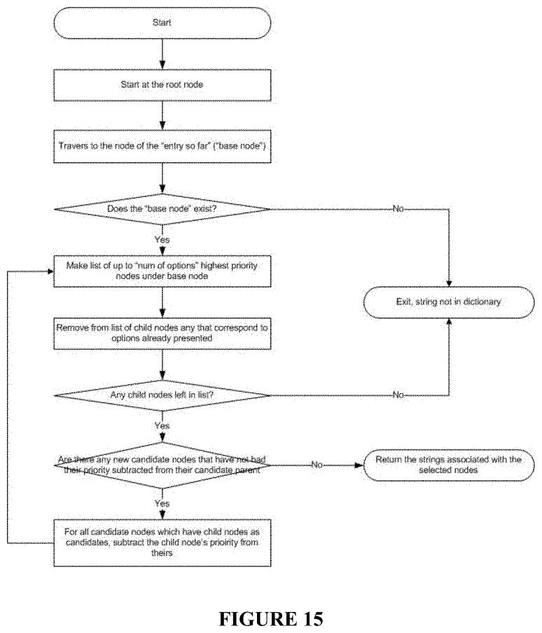

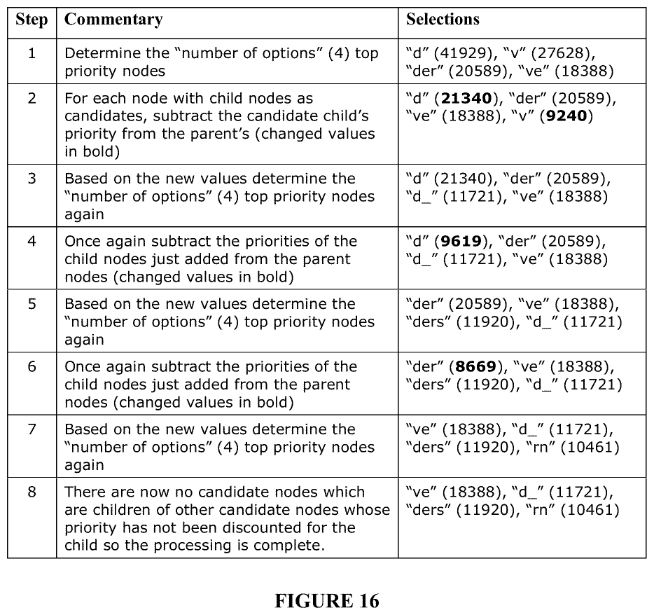

To determine this the system would apply the exemplary logic illustrated in FIG. 15 and described in Table 3 (FIG. 16) based on the example of determining the options for the “entry so far” of “lea” in FIG. 10. The “number of options” figure in this example would be 4 and there would be no items displayed already. Thus the option that would be presented are “ye”, “d_”, “ders” and “rn”. This method of lookup is the most dynamic of the ones described as it maintains and refers to the priority at all times so that the priority values can change and the menus can reflect the new priorities immediately.

In the above descriptions, the dynamic tree structure is illustrated with one or more characters (or the end of word symbol) making up the string at each node. This is because the logic of the system is based on where the strings in the dictionary branch and options are presented based on this notion.

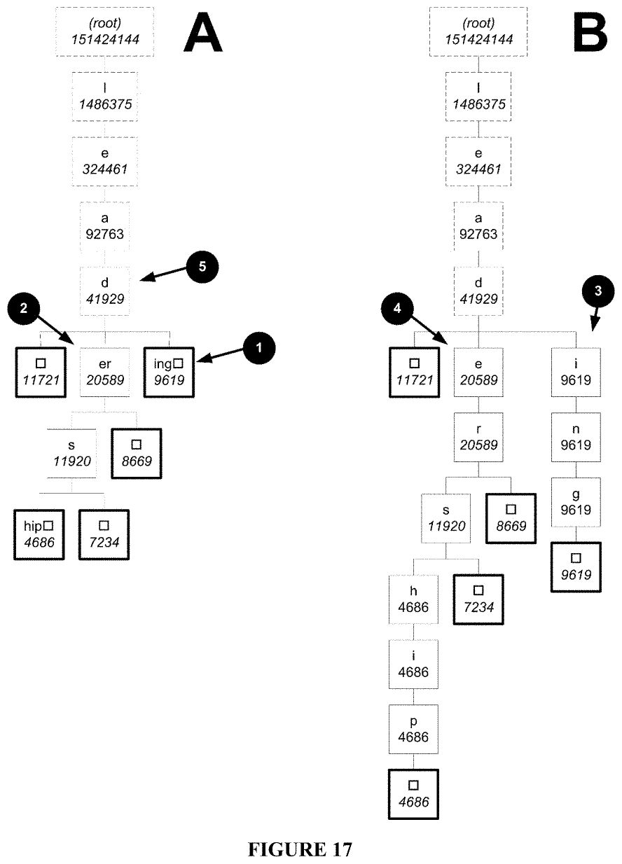

However, there may be circumstances where the structure has to be changed slightly to limit each node to a single character. FIG. 17 illustrates an example of how this may be implemented. Referring to FIG. 17, tree section (A) illustrates the nodes that make up the word beginning “lead” (the nodes for the letters to this point are likely to have several other branches not illustrated in FIG. 17) and the fully expanded tree of nodes that may make up all the words starting with “lead”.

As can be seen in FIG. 17 (A), leaf node (1) contains the multi-character string section “ing_”, similarly the branch node (2) contains the multi-character string section “er”.

The tree structure can be reconfigured to that illustrated in FIG. 17 (B) whereby all nodes with more than one character in them can be expanded to a sequence of single character nodes all with the same priority value and a single link to a subsequent node. So node (1) is expanded to a string of 4 nodes starting at (3) and node (2) is expanded to a string of 2 nodes starting at (4). The lookup logic for this modified structure is similar to that described above with the additional consideration that when determining a string for a node, the system should include that node as well as the characters for the nodes under the node up to the first branch or end node.

There are potentially many situations where this structure may be useful, two are described below.

If a system allows for entry, or selection, of characters outside the string sections that make up the branches of the Partial Word Completion based dictionary (the “options”), the “entry so far” may end up resulting in a string which maps to part way through the text of a node. For example, the user may use a Partial Word Completion based system to enter the initial string of “lead” using a tree of data as illustrated in FIG. 17 (A), they may then use some explicit character entry means to enter the letter “i”. The next time the engine component is called to present options, the entry so far will be “leadi” and given a structure as in FIG. 16 (A), this leads to a point which is within the string for node (1). As a result, it may not be possible to determine the options to present. However given a structure as in FIG. 17 (B) it is a simpler task for the system to traverse to node (3) and hence present the string made up of the child nodes (just the one string “ng_”) as the options to present.

As described above, there may be circumstances where selection is provided through multiple simultaneous dictionaries being traversed in parallel. In this situation, it cannot be guaranteed that for any particular entry so far that all the dictionaries will traverse to the start of a node string in the case where there are multiple characters per node. However, if each dictionary structure is limited to a single character per node this issue is removed. The above description suggests converting single nodes with multiple characters into multiple, single character nodes. The implementation may literally do this and such a structure is quite acceptable

However, it may be possible to implement the described structure in a “virtual” way such that the internal storage of the dictionary still allows for multi-character nodes as this may be more efficient in terms of storage and required processing. However, as the system traverses through the tree it works a character at a time as if there was just one character per node but maintains additional information internally to allow it to traverse the multi-character string of a node a character at a time. This may be done through a virtual node pointer. In previous descriptions, traversal of the tree was managed through a pointer which was navigated through the nodes. A virtual pointer could be implemented through the maintenance of a memory of a node pointer plus an index of the character that the virtual pointer is at within the node that the node pointer is pointed at.

For instance, if the word so far is “lead” then the node pointer may point at node (5) in FIG. 17 (A) and a character index value of 0 indicating that the virtual pointer is at the first character. However, if the user then enters “e” by some other means the node pointer would move to node (2) with the character index value of 0 indicating that the virtual pointer is at the first character “e”. This would mean that the “r” component would be treated as a virtual subnode. If the user then entered or selected “r”, the node pointer would remain at node 2 but the character index would change to 1 indicating that the virtual pointer is now at the second character in “er”.

The above described several approaches to determining the menu options to present to the customer, other methods may be used.

In the alternative “static tree” methodology the system maintains internal data in a tree form reflecting the structure of the menu of options to be presented to the user as they navigate a selection as opposed to the structure of the source data strings. Unlike the dynamic tree structure described above, this structure may not provide the ability to dynamically change the priorities and hence the order in which options are presented without the need for a restructuring of the internal data. However, the static tree structure has the advantage of requiring minimal processing by the application to determine the desired menu options at a particular point in the selection process. This facilitates Partial Word Completion based selection to run more efficiently on computing devices with limited processing power. When a set of Partial Word Completion options are needed, the internal logic traverses the tree and returns the best options to present. As described above, a Partial Word Completion based system may determine and present a series of menus of options for the user to select from. As the user selects options and builds up their selection to the point where the full text of the item is entered a tree structure of menu items is navigated through. If a system was to take the role of the user and traverse the tree of options that were generated by a Partial Word Completion based selection mechanism and store the contents of each menu at each level by following all branches in turn to the end points, the system would build up an internal tree structure which directly reflected the menus to present for navigation to any of the items that have been indexed.

Unlike the dynamic tree structure which is based on the structure of the language or items to be selected, the static tree structure being described here may be based on the structure of the menus to be presented as selections are made. As such a static tree structure may be specific to a particular value for the number of menu items being presented, e.g. a static tree structure generated for a system presenting 4 items at a time may not be capable of being used efficiently to generate options 5 at a time.

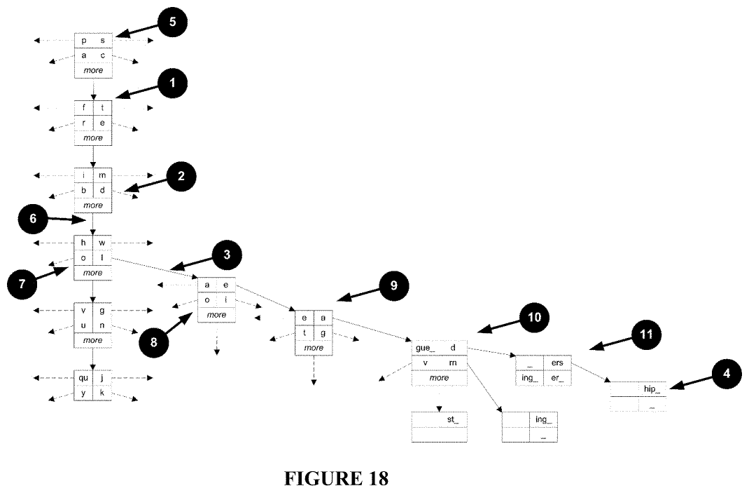

FIG. 18 illustrates a sample section of a static tree structure. Each node (1) in the diagram represented by a rectangular box corresponds to a menu to be presented. In the case of FIG. 18, the tree structure illustrated is for a Partial Word Completion based system which is presenting four options plus, possibly, a “more” option on each menu. This is typical for a joystick driven system when the four options correspond to joystick movements in the directions up, right, down and left and the “more” option is some other action such as a press in the middle of the joystick.

Referring to FIG. 18, where the selection of an option leads onto another menu (and hence another node (1)) this is represented by a directional line ((2) and (3)) showing the links. Links (2) with a dashed line indicate that the selection of that item leads onto further menu branches but they have not been illustrated in FIG. 18, however links (3) with a solid line indicate that the selection leads on to further menus and these have been illustrated in FIG. 18.

Where a selection has no link line off it such as that illustrated by (4) this is an end selection. When the systems allows the user to traverse through the menus from the from the root node (5) to an end selection and concatenates the strings of each selection in sequence they would build up the string associated with the end selection reached. For example, if a system traverses to the end selection (4), it would build up the string sections: “l”, “e”, “a”, “d”, “ers”, “hip” making the word “leadership”. Note that selection of a “more” option navigates to the indicated menu but does not result in the appending of any string sections.

As described herein, whatever the mechanism used for the interface component to supply parameters to the engine component, the engine component is likely to have, or be provided with, a knowledge of: the “dictionary data” that that the system should use to base its menu option suggestions on (this may be a reference to a file, a pointer to internal memory or any other means of indicating the location or contents of the data—this data may be in any format that can be processed by the engine component; the “entry so far”, i.e. the part of the word, string or item being selected that has been entered so far); the “rejected options” (the menu options that have already been presented and rejected through selection of the “more” function (if any) for the current “entry so far” or a number indicating the number of full menus of options that have been rejected through the “more” function (if any) for the current “entry so far”); and the “number of options” (the number of menu options to return).

It should be noted that as the static tree structure is more menu-oriented, it is likely that the most efficient way for the interface component to issue requests to the engine component would be by using the “Transaction level state maintained” communication method described above. However, this does not preclude the use of one or more other methods described earlier or other systems that are not listed in this document to pass information between the interface component and the engine component.

As such, it is likely that the “rejected options” data is more likely to be the number of rejected full menus rather than a list of rejected options as the latter could theoretically result in an option set to be presented that does not mesh with the menu structure in the static tree. E.g. if the “number of options” is 4 then having 2 menus rejected is simply a matter of bypassing those menus in the tree structure, however, having 6 menu options rejected when the first two menus are composed of 8 menu options may not be compatible with data in a static tree structure.

The following description of the lookup logic for the system assumes that the system is using the “Transaction level state maintained” communication method described above, but as stated earlier, this is not the only method by which the system could be implemented.

The engine component traverses the tree to identify the appropriate menu option set to return to the interface component to present to the user.

In one embodiment of the system the engine may maintain a memory of the “current menu” pointer. Referring to the possible values for parameters as discussed earlier, on a request from the interface component for a menu option set, the system may apply the following logic on each call to the engine component to traverse the static tree and return to the interface component the options it should present. At the start of a selection or when the action parameter supplied was “start”, the system would move the “current menu” pointer to the initial menu (in FIG. 18 this is indicated with (5)) and clear the “entry so far”. If the parameter is “more” and the “current menu” has a “more” option, the “current menu” would be moved to the menu indicated by the “more” option in the node (for example (6)) and no text would be appended to the “entry so far”. If the parameter is “back” then the system would revert back to the previous state including the previous menu and value of “entry so far”—this may entail moving the “current menu” pointer back to its previous location, or if the “current menu” is at the initial menu, removing the last appended string from the “entry so far”. If the parameter indicates an option has been selected then the string for that option may be appended to the “entry so far” and the “current menu” may be moved to the menu linked to by that option in the current menu. For example, if the “current menu” is that indicated by (7) in FIG. 18 (and hence the user is presented with the four selections: “w”, “l”, “o” and “h”) and the user selects “l” then “l” may be appended to the “entry so far” and the “current entry” may be moved down the corresponding link (3) to menu node (8) and the new menu with values: “e”, “i”, “o” and “a” may be presented to continue the text starting with “l”. If there is no link corresponding to the selected option, then this is the end of a selection—this may be indicated to the calling system by appending some end-of-word character to the “entry so far”. If the parameter is “reload” the system may not make any changes to the state. The system then may return the strings that correspond to each of the options in the “current menu”, if the system has reached an end selection, there may be no options returned. The system may also return the “entry so far” or information about how the “entry so far” string has been modified by the last action (e.g. “append ‘l’”) so that the interface component can present the modified entry so far.

In an exemplary embodiment of this logic, the user intends to enter the word “leadership”. The interface is based on a five way joystick input with a menu indicating Partial Word Completion options in four directions of movement of the joystick similar to the menu in FIG. 6A.

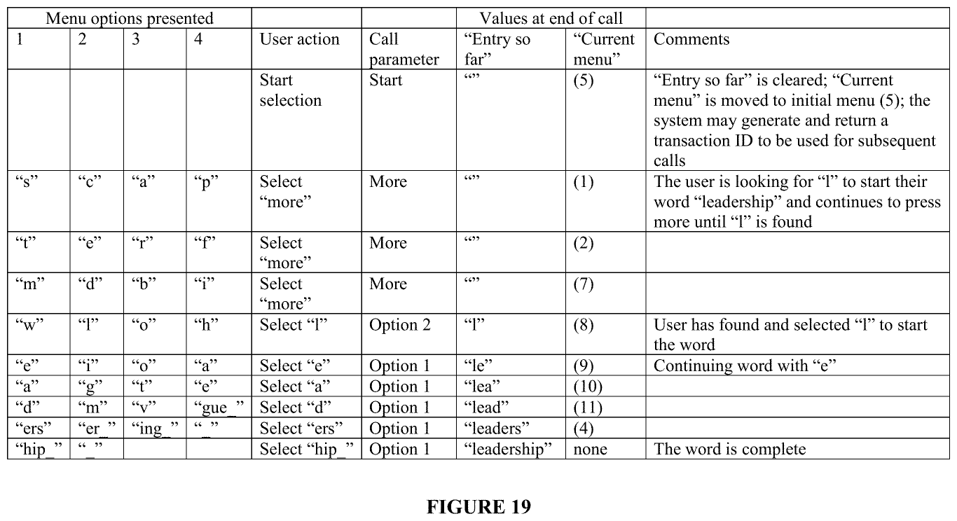

The interface component would initiate the selection by calling the engine component with a “start” action. A possible sequence of actions based on the internal static tree structure illustrated in FIG. 18 would follow the sequence illustrated in Table 4 (FIG. 19).

As discussed, in addition to the initial word list that the system is loaded with, the system may also optionally learn new words as the user uses them. As words are entered that the system knows it may boost the frequency value of the words giving them greater priority in subsequent usages. When the user enters words that the system does not know then the system could add these to the word list so that they are available for the next instance. For this to work, the data set may be stored in persistent storage between activations of the system.

A learning function may be activated when explicit character entry results in the entry of a word that is not in the programmed vocabulary of the Partial Word Completion text entry system. In this case it may be desirable to take note of the word that is ultimately entered and add it to the Partial Word Completion system's vocabulary such that that word is available in the Partial Word Completion predictive process from that point on. Although a Partial Word Completion system with a sufficiently broad dictionary should allow for entry of the majority of words by building up selections of Partial Word Completion options from known words, there may be times that an unknown word has to be entered such as a proper noun. Thus a text entry system based on Partial Word Completion should provide some means for explicit character-by-character spelling out of words that are not in the Partial Word Completion dictionary. Once such a word has been entered, the Partial Word Completion may incorporate that word in the index so that it can be entered purely via Partial Word Completion subsequently.

In addition to presenting text input of words in a Partial Word Completion based text entry system it may be desirable to provide input of frequently used combinations of words (phrases) with the included “white space” characters such as the space character. There are several ways this could be implemented, below are described two of these possibilities.

Phrases could be stored in the dictionary along with the other words for the language. In this case, phrases may be supplied to the system in the same way that the other words are included in the dictionary through some analysis of the vocabulary. So the dictionary would be populated with the most popular words of the language as well as the most popular phrases of the language. In addition, or instead, there may be a learning component which keeps track of phrase usage and adds more frequently used sets of words (phrases) to the dictionary based on their usage. As phrases are simply a sequence of character like words, it should be possible to store them in the same structure as the dictionary for words. The difference being that the phrase entries would include characters that represent a space character or other white space character.

Another way of incorporating a predictive mechanism based on sequences of words is for the system to maintain in the dictionary a knowledge of the likelihood of sequences of words. For instance when a particular word is completed, it may be common for that word to be followed by other particular words. If the system maintains a knowledge of the likely following words as well as their likelihood then they can use that likelihood to give the options representing that following word greater priority in the selection Partial Word Completion based selection process for the following word.

For instance, if the system is aware that when a user enters “united” then there is a higher likelihood than normal that they will enter the words “states” or “airlines” the options presented for these two words can be given a higher priority for the entry of the word following “united” but then the priorities for the words “states” and “airlines” would revert back to normal for subsequent entries.

The likelihood knowledge that the phrase prediction is based on may be provided as the dictionary is generated based on an analysis of the language through some means to determine the likelihood of words following each other. In addition, or instead, the likelihood values may be derived by monitoring usage of the system. Also the likelihood values may be determined by the system performing an analysis on a set of documents by counting the frequencies of words, phrases, etc. in those documents.

An enhancement to implementations of Partial Word Completion based systems may be the provision of text entry based on multiple, simultaneous dictionaries. This may be advantageous when the system is providing selection from multiple languages. E.g. If the user wants to enter French and/or English terms it may make sense to provide this as two Partial Word Completion dictionaries being traversed simultaneously, or when the system is providing text entry with both one or more predefined dictionaries as well as a dynamic dictionary of learned words. In this case, it may be disadvantageous to have the learning facility updating the main dictionary as this dictionary may be large and updating it repeatedly may be slow and inefficient. Thus it may be preferable to have one or more static dictionaries which hold the initial language definitions and a smaller dynamic dictionary which builds up a tree of new words used by the user or monitors existing word usage frequency to override the predefined priorities for those words. This may also be advantageous for the purposes of optimising storage or other computer resources it may be advantageous to be able to split a large dictionary into several smaller dictionaries which are still selected from as one.

As described above, the system could be implemented with an interface component which handles the interaction with the user and engine component which manages the process of traversing the Partial Word Completion based dictionary(s) and determines the options to be presented to the user. Under such a scheme the logic to implement selection from multiple simultaneous dictionaries is likely to largely reside in the engine component. In the description of the engine component two basic tree structures were proposed: a “dynamic” structure and a “static” structure. One possible implementation of multiple simultaneous dictionaries indexed in a dynamic tree structure is described below.

When there is a single dictionary, the lookup logic entails traversing the tree to the node which corresponds to the entry so far, and if a node is found, removing all the branches below that node from consideration that have been presented previously and rejected through a “more” option, then analysing all the remaining branches coming off the node (each of which represents a continuation from the current entry so far) to determine the relative priority of each one, and selecting the “num of entries” remaining branches that have the highest priority which are then presented to the user.

In order to implement multiple dictionaries, the lookup logic performed in the engine component may be similar to this but carried out with multiple dictionaries in parallel. Thus, on a request for a set options to present the engine component may perform the following operations: For all active dictionaries traversing the tree to the node that corresponds with the entry so far (some dictionaries may not have a corresponding node for the current entry so far in which case those dictionaries would be removed from consideration for this selection), and if at least one node is found; determining all branches off all the nodes found in the above step, where there are branches from different dictionaries which correspond to the same continuation, combine their relative priorities and treat them as a single “virtual” node, compile a set of all branches either combined in this manner or unique throughout the dictionaries; from the set of branches derived in the above set, remove any branches that have been rejected through a previous selection of a “more option”; and select the “num of entries” remaining branches in the set that have the highest priority and return them for presentation as Partial Word Completion options to the user.

For the above logic there are several considerations that may need to be taken into account. For example, a particular “entry so far” may not exactly equate to a node in the tree structures of each of the dictionaries so it may be advantageous to implement the dictionary tree structures with a structure that limits each node to having one character. Additionally, in determining the priority of a “virtual” node which is the result of a combination of multiple nodes it may be sufficient to simply sum the priorities of all the component nodes together. However, there is scope for the system to apply more complex prioritization logic. For instance it may apply different weights to nodes from different dictionaries before summing them together, possibly by applying different multiples to the base priority of each node in different dictionaries.

For instance, if there is a static, language dictionary, as well as a dynamically learning usage dictionary which holds new words and modified usage values of used words, the system may give the usage dictionary higher priority as it is more likely that the desired word will be one that has been used previously.

Similarly, if the user has active an English and French dictionary in order to enter text in either language but their native language is French and hence they enter more text in French, the system may allow the user the option of applying higher priority to the French dictionary nodes.

In implementing multiple simultaneous dictionaries where the dictionaries are indexed using a static structure it may be possible for the engine component to provide this by getting the proposed options from each dictionary for the entry so far, compiling them into a larger list and removing duplicates, then presenting them “number of options” at a time for each request for more options from the interface component.

In addition to provision of entry of text characters by Partial Word Completion, it may be advantageous to provide entry of items made up of other components than characters. These components may be graphical, audible, tactile, etc. Whenever a system provides entry of items from a list of multiple items, the items being composed of a sequence of components and these sequences of components can be included in a text document (or other mechanism for recording sequences of items), then Partial Word Completion could be applied to the entry of those components. This may include selection of items of text made up of characters, symbols, accents, graphics components, etc. which may include such things as smileys, arrows, drawing items like blocks, images, etc. However, it should be noted that the system could also be applied to many other applications where items are made up of a sequence of components. Exemplary possibilities to demonstrate the diversity of applications include, but are not limited to, music notes, chess moves, choreography steps, DNA sequence, tunes and sign language.

An example of this may include computer programming languages, database query languages, etc. (e.g. C++, SQL, . . . ). In this case there are a relatively small number of words in the language (e.g. “for”, “if”, “then”, “case”) so selection of these will be extremely rapid using Partial Word Completion. In addition there may be frequently used sequences of words, symbols, etc. (the equivalent of phrases) such as “for (i=0; i<” or “select * from” which Partial Word Completion could assist with the entry of. Also, the Partial Word Completion system could be aware of other programming aspects such as the names of the variables that have been declared and make them available for entry via menus as well.

Partial Word Completion based text entry can be used to streamline the process of entry of specialist dictionaries of a language in addition to, or instead of, the dictionary for common terms for that language. Examples of this may include, but are not limited to, medical terms, chemistry terms, legal terms, jargon/slang terms specific to a profession, social group, nationality, etc., abbreviated text terms such as those used in text messages, any other specialist dictionary.

These dictionaries may be presented independently in a Partial Word Completion based text entry or incorporated for simultaneous entry with other dictionaries of a more general nature or other specialist dictionaries, possibly by the multiple dictionary mechanism described herein.

The system could also be used to enter data which is non-alphabetic such as a Partial Word Completion indexed selection of Internet Protocol or “IP” addresses. Depending on the standard (IP4 versus IP6) and the numeric system (decimal versus hex), these addresses may take the form of: <number 0-255>.<number 0-255>.<number 0-255>.<number 0-255>. Whilst these are all numeric and the character “.” A Partial Word Completion could be indexed on a list of know IP addresses and allow for a text system to provide rapid entry of these.

As with conversational text above there may be provisions for explicit entry of characters to spell out (and possibly add to the dictionary) new, unknown technical texts that are not indexed and hence not available through the Partial Word Completion menu.

Also as with conversational text above the system may provide a system for entering punctuation, symbols, etc. and in addition there may be multi-character technical text components that are used so frequently they could be supplied in the same manner as punctuation marks. For instance on the entry of web page addresses (URLs) it may be advantageous to offer the following as entry options: “http://”, “www.” and “.com”.

In addition to entry of standard Latin characters as is the case with languages such as English, there are other languages which may benefit from Partial Word Completion based text entry. Examples of these include some languages from Asia and the Middle East. A symbol used in these languages may correspond to a particular concept in the same way English words do, or it may take several symbols to compose the English equivalent of a word or a single symbol may correspond to multiple words, a phrase or sentence in English. Moreover, each symbol may be composed of multiple strokes or other primitives to build the symbol, these strokes may appear in different combinations to compose other symbols. Despite the differences in construction of other languages it is still possible to use a Partial Word Completion based text entry system to provide input of them. As long as the same principals apply in that a Partial Word Completion system analyses common usage of the language and builds up a structure to reflect how the components are built up from start to finish then that Partial Word Completion based system will be able to provide entry in that language.

It will be appreciated by persons skilled in the art that numerous variations and/or modifications may be made to the invention as shown in the specific embodiments without departing from the spirit or scope of the invention as broadly described. The present embodiments are, therefore, to be considered in all respects as illustrative and not restrictive.

1. A method of entering information, the method comprising:
generating an initial display including one or more parts of a word for selection;
enabling selection of the one or more parts and in response to selection of the one or more parts;
generating a display of a further one or more parts of the word for selection;
and enabling selection of the further one or more parts of the word in order to add to the selected one or more parts to build a larger part or whole of a word.

2. The method according to claim 1, further comprising iterating the selection steps until the word is completed.

3. The method according to claim 1, wherein generating the initial display includes entering the one or more parts of the word to be displayed based on a prioritization scheme.

4. The method according to claim 1, wherein generating the initial display includes entering the one or more parts of the word to be displayed and based on the one or more parts of the word entered generating a display of a further one or more parts of the word for selection based on some knowledge of the text indices and the likelihood of the string or word sections to be the ones the user wants to enter.

5. The method according to claim 1, wherein, the words generated are from at least two languages.

6. The method according to claim 1, wherein said method is performed in a computing device and the computing device is a mobile telephone.

7. The method according to claim 1, wherein said method is performed in a computing device and the computing device is a PDA.

8. The method according to claim 1, wherein selection of the one or more parts is enabled by way of a joystick.

9. The method according to claim 8, wherein said joystick is a five-way joystick.

10. The method according to claim 1, wherein selection of the one or more parts is enabled by way of a touch screen.

11. The method according to claim 1, wherein selection of the one or more parts is enabled by way of programmable keys.

12. The method according to claim 1, wherein the method is performed on a computing device and said collection of words is stored on the computing device.

13. The method according to claim 1, wherein the method is performed on a computing device and said collection of words is stored on a remote device.

14. The method according to claim 1, wherein generating said initial display includes selecting the one or more parts of the word to be displayed based on a dynamic prioritization scheme that adjusts priorities of the one or more parts of the word based on the number of times the word or the one or more parts of the word was previously selected.

15. The method according to claim 1, wherein selection using said method takes between about 10% and about 85% less time than for a conventional system.

16. The method according to claim 1, wherein selection using said method takes between about 10% and about 70% less key presses than for a conventional system.

17. The method according to claim 1, wherein selection using said method results in between about 10% and about 70% fewer errors than that of conventional systems.

18. The method according to claim 1, wherein the information entered is text.

19. The method according to claim 1, wherein the method further comprises generating a display of at least one function comprising: capitalisation, italic, bold, choice of font, colour, editing functions, deletion, cut, copy, paste, spell checking, grammar checking, word counting, and/or translation;
enabling selection of the function for selection; and
performing the at least one function selected.

20. The method according to claim 1, wherein the method further comprises generating a display of at least one of a punctuation mark, a symbol, an accent, or a graphic;
enabling selection of the at least one punctuation mark, symbol, accent, or graphic; and
adding the at least one of the punctuation mark, the symbol, the accent, or the graphic to the information.

21-24. (canceled)
